(19) United States
(12) Patent Application Publication
(10) Pub. No.: US 2024/0393502 A1
(43) Pub. Date: Nov. 28, 2024

(54) OPTICAL ELEMENT, OPTICAL SYSTEM, IMAGE PICKUP APPARATUS, AND MANUFACTURING METHOD OF AN OPTICAL ELEMENT

(71) Applicant: CANON KABUSHIKI KAISHA, Tokyo (JP)

(72) Inventor: Kazue UCHIDA, Tochigi (JP)

(21) Appl. No.: 18/664,381

(22) Filed: May 15, 2024

(30) Foreign Application Priority Data
May 24, 2023 (JP) 2023-085504
Mar. 13, 2024 (JP) 2024-039020

(51) Int. Cl. G02B 1/11

(52) U.S. Cl. CPC G02B 1/11

(57) ABSTRACT

An optical element includes a base material, and an antireflection film. The antireflection film consists of a first layer formed on the base material, a second layer formed on the first layer, and a third layer formed on the second layer. Each of the first layer, the second layer, and the third layer includes an organic compound. A predetermined inequality is satisfied.

### BACKGROUND

### Technical Field

One of the aspects of the embodiments relates to an optical element, an optical system, an image pickup apparatus, and an optical element manufacturing method.

### Description of Related Art

To prevent flare and ghost due to unnecessary reflection, a dielectric multilayer film (antireflection film) with an antireflection function can often form on the surface of an optical element (e.g., a lens or a filter), of an optical system. The antireflection film can exhibit high antireflection performance in a case where its top layer is made of a material having a low refractive index. The material having a low refractive index is known to be an inorganic material such as silica or magnesium fluoride, or an organic material (e.g., silicon resin or amorphous fluorine resin). The refractive index of such a material can be decreased by forming a void in a layer which is formed of the material.

Japanese Patent Laid-Open No. 2009-162989 discloses a two-layer antireflection film that consists of a first layer including alumina as a primary component and a second layer of silica aerogel having a refractive index of 1.27, and is formed on a substrate having a refractive index of 1.70 to 1.95.

In the antireflection film disclosed in Japanese Patent Laid-Open No. 2009-162989, the first layer including alumina as a primary component is formed by evaporation. Thus, in a large open lens, film unevenness occurs on the lens surface, and antireflection performance (e.g., reflectance reduction) on the entire lens surface is not sufficient. Furthermore, since the refractive index of the second layer (i.e., the top layer) is approximately 1.27, the antireflection performance is not sufficient in a case where the substrate has a lower refractive index.

### SUMMARY

An optical element according to one aspect of the disclosure includes a base material, and an antireflection film. The antireflection film consists of a first layer formed on the base material, a second layer formed on the first layer, and a third layer formed on the second layer. Each of the first layer, the second layer, and the third layer includes an organic compound. the following inequality is satisfied:

$$1.10 \leq {n}_{3} \leq 1.28$$

where n₃ is a refractive index of the third layer for light with a wavelength of 550 nm.

An optical element according to another aspect of the disclosure includes a base material, and an antireflection film. The antireflection film consists of a first layer formed on the base material, a second layer formed on the first layer, and a third layer formed on the second layer. The following inequalities are satisfied:

$$1.3 \leq {n}_{1} \leq 1.5$$

$$1.56 \leq {n}_{2} \leq 1.7$$

$$1.1 \leq {n}_{3} \leq 1.28$$

$$10 \leq {n}_{1} {d}_{1} \leq 155$$

$$10 \leq {n}_{2} {d}_{2} \leq 155$$

$$100 \leq {n}_{3} {d}_{3} \leq 155$$

$$200 \leq {n}_{1} {d}_{1} + {n}_{2} {d}_{2} + {n}_{3} {d}_{3} \leq 300$$

where n1 is a refractive index of the first layer for light with a wavelength of 550 nm, n2 is a refractive index of the second layer for the light with the wavelength of 550 nm, n3 is a refractive index of the third layer for the light with the wavelength of 550 nm, d1 (nm) is a thickness of the first layer, d2 (nm) is a thickness of the second layer, and d3 (nm) is a thickness of the third layer.

An optical system having one of the above optical elements and an image pickup apparatus having one of the above optical elements also constitute another aspect of the disclosure. A manufacturing method of one of the above optical elements also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram of an optical element according to each of Examples 1 to 14.

FIG. 2 is a schematic sectional view of an optical element according to each of Examples 1, 2, 5, 7, 8, 11, and 13 and comparative examples 1 and 2.

FIG. 3 is a schematic sectional view of an optical element according to each of Examples 3, 4, 6, 9, 10, 12, and 14.

FIG. 4 illustrates the reflectance characteristic of the optical element according to Example 1 for incident angles of 0°, 15°, 30°, 45°, and 60° at position C.

FIG. 5 illustrates the reflectance characteristic of the optical element according to Example 1 at the incident angle of 0° at positions C and Q.

FIG. 6 illustrates the reflectance characteristic of the optical element according to Example 2 for incident angles of 0°, 15°, 30°, 45°, and 60° at position C.

FIG. 7 illustrates the reflectance characteristic of the optical element according to Example 2 at the incident angle of 0° at positions C and Q.

FIG. 8 illustrates the reflectance characteristic of the optical element according to Example 3 for incident angles of 0°, 15°, 30°, 45°, and 60° at position C.

FIG. 9 illustrates the reflectance characteristic of the optical element according to Example 3 at the incident angle of 0° at positions C and Q.

FIG. 10 illustrates the reflectance characteristic of the optical element according to Example 4 for incident angles of 0°, 15°, 30°, 45°, and 60° at position C.

FIG. 11 illustrates the reflectance characteristic of the optical element according to Example 4 at the incident angle of 0° at positions C and Q.

FIG. 12 illustrates the reflectance characteristic of the optical element according to Example 5 for incident angles of 0°, 15°, 30°, 45°, and 60° at position C.

FIG. 13 illustrates the reflectance characteristic of the optical element according to Example 5 at the incident angle of 0° at positions C and Q.

FIG. 14 illustrates the reflectance characteristic of the optical element according to Example 6 for incident angles of 0°, 15°, 30°, 45°, and 60° at position C.

FIG. 15 illustrates the reflectance characteristic of the optical element according to Example 6 at the incident angle of 0° at positions C and Q.

FIG. 16 illustrates the reflectance characteristic of the optical element according to Example 7 for incident angles of 0°, 15°, 30°, 45°, and 60° at position C.

FIG. 17 illustrates the reflectance characteristic of the optical element according to Example 7 at the incident angle of 0° at positions C and Q.

FIG. 18 illustrates the reflectance characteristic of the optical element according to Example 8 for incident angles of 0°, 15°, 30°, 45°, and 60° at position C.

FIG. 19 illustrates the reflectance characteristic of the optical element according to Example 8 at the incident angle of 0° at positions C and Q.

FIG. 20 illustrates the reflectance characteristic of the optical element according to Example 9 for incident angles of 0°, 15°, 30°, 45°, and 60° at position C.

FIG. 21 illustrates the reflectance characteristic of the optical element according to Example 9 at the incident angle of 0° at positions C and Q.

FIG. 22 illustrates the reflectance characteristic of the optical element according to Example 10 for incident angles of 0°, 15°, 30°, 45°, and 60° at position C.

FIG. 23 illustrates the reflectance characteristic of the optical element according to Example 10 at the incident angle of 0° at positions C and Q.

FIG. 24 illustrates the reflectance characteristic of the optical element according to Example 11 at the incident angles of 0°, 15°, 30°, 45°, and 60° at position C.

FIG. 25 illustrates the reflectance characteristic of the optical element according to Example 11 at the incident angle of 0° at positions C and Q.

FIG. 26 illustrates the reflectance characteristic of the optical element according to Example 12 for incident angles of 0°, 15°, 30°, 45°, and 60° at position C.

FIG. 27 illustrates the reflectance characteristic of the optical element according to Example 12 at the incident angle of 0° at positions C and Q.

FIG. 28 illustrates the reflectance characteristic of the optical element according to Example 13 for incident angles of 0°, 15°, 30°, 45°, and 60° at position C.

FIG. 29 illustrates the reflectance characteristic of the optical element according to Example 13 at the incident angle of 0° at positions C and Q.

FIG. 30 illustrates the reflectance characteristic of the optical element according to Example 14 for incident angles of 0°, 15°, 30°, 45°, and 60° at position C.

FIG. 31 illustrates the reflectance characteristic of the optical element according to Example 14 at the incident angle of 0° at positions C and Q.

FIG. 32 is a sectional view of an optical system according to Example 15.

FIG. 33 is an external perspective view of an image pickup apparatus according to Example 16.

FIG. 34 illustrates the reflectance characteristic of the optical element as comparative example 1 for incident angles of 0°, 15°, 30°, 45°, and 60° at position C.

FIG. 35 illustrates the reflectance characteristic of the optical element as comparative example 1 at the incident angle of 0° at positions C and Q.

FIG. 36 illustrates the reflectance characteristic of the optical element as comparative example 2 for incident angles of 0°, 15°, 30°, 45°, and 60° at position C.

FIG. 37 is a schematic diagram of an optical element according to each of Examples 17 to 25.

FIG. 38 is a schematic sectional view of the optical element according to each of Examples 17, 19, 21, and 22 and comparative examples 1 and 2.

FIG. 39 is a schematic sectional view of the optical element according to each of Examples 18, 20, and 23.

FIG. 40 is a schematic sectional view of the optical element according to Example 24

FIG. 41 is a schematic sectional view of the optical element according to Example 25.

FIG. 42 illustrates the reflectance characteristic of the optical element according to Example 17 for incident angles of 0°, 15°, 30°, 45°, and 60° at position C.

FIG. 43 illustrates the reflectance characteristic of the optical element according to Example 17 at the incident angle of 0° at positions C and Q.

FIG. 44 illustrates the reflectance characteristic of the optical element according to Example 18 for incident angles of 0°, 15°, 30°, 45°, and 60° at position C.

FIG. 45 illustrates the reflectance characteristic of the optical element according to Example 18 at the incident angle of 0° at positions C and Q.

FIG. 46 illustrates the reflectance characteristic of the optical element according to Example 19 for incident angles of 0°, 15°, 30°, 45°, and 60° at position C.

FIG. 47 illustrates the reflectance characteristic of the optical element according to Example 19 at the incident angle of 0° at positions C and Q.

FIG. 48 illustrates the reflectance characteristic of the optical element according to Example 20 for incident angles of 0°, 15°, 30°, 45°, and 60° at position C.

FIG. 49 illustrates the reflectance characteristic of the optical element according to Example 20 at the incident angle of 0° at positions C and Q.

FIG. 50 illustrates the reflectance characteristic of the optical element according to Example 21 for incident angles of 0°, 15°, 30°, 45°, and 60° at position C.

FIG. 51 illustrates the reflectance characteristic of the optical element according to Example 21 at the incident angle of 0° at positions C and Q.

FIG. 52 illustrates the reflectance characteristic of the optical element according to Example 22 for incident angles of 0°, 15°, 30°, 45°, and 60° at position C.

FIG. 53 illustrates the reflectance characteristic of the optical element according to Example 22 at the incident angle of 0° at positions C and Q.

FIG. 54 illustrates the reflectance characteristic of the optical element according to Example 23 for incident angles of 0°, 15°, 30°, 45°, and 60° at position C.

FIG. 55 illustrates the reflectance characteristic of the optical element according to Example 23 at the incident angle of 0° at positions C and Q.

FIG. 56 illustrates the reflectance characteristic of the optical element according to Example 24 for incident angles of 0°, 15°, 30°, 45°, and 60° at position C.

FIG. 57 illustrates the reflectance characteristic of the optical element according to Example 24 at the incident angle of 0° at positions C and Q.

FIG. 58 illustrates the reflectance characteristic of the optical element according to Example 25 for incident angles of 0°, 15°, 30°, 45°, and 60° at position C.

FIG. 59 illustrates the reflectance characteristic of the optical element according to Example 25 at the incident angle of 0° at positions C and Q.

FIG. 60 illustrates the reflectance characteristic of the optical element as comparative example 3 for incident angles of 0°, 15°, 30°, 45°, and 60° at position C.

FIG. 61 illustrates the reflectance characteristic of the optical element as comparative example 3 at the incident angle of 0° at positions C and Q.

FIG. 62 illustrates the reflectance characteristic of the optical element as comparative example 4 for incident angles of 0°, 15°, 30°, 45°, and 60° at position C.

### DESCRIPTION OF THE EMBODIMENTS

Examples will now be described in detail with reference to the accompanying drawings.

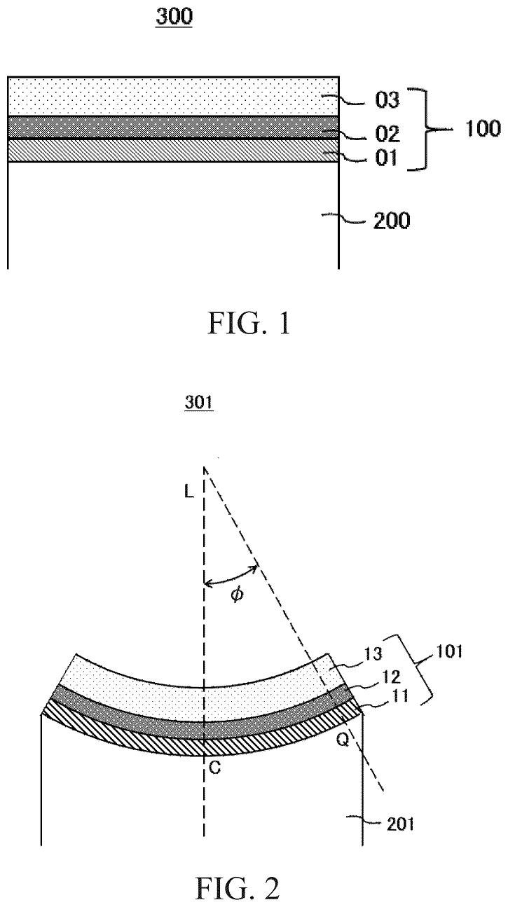

Referring now to FIG. 1, a schematic description will be given of an optical element 300 according to each of Examples 1 to 14. FIG. 1 is a schematic diagram of the optical element 300. The optical element 300 includes a transparent substrate (base material) 200 and an antireflection film 100 that consists of three layers. The “layer,” as used herein, refers to a group of parts made of the same material. That is, two adjacent layers are made of different materials, and an interface exists between them. The antireflection film 100 consists of, in order from the transparent substrate 200 toward an air side, a thin film layer (first layer) 01, a thin film layer (second layer) 02, and a thin film layer (third layer) 03.

In the examples, the thin film layers 01, 02, and 03 of the optical element 300 may be made of a material including an organic compound. The organic compound is a compound including carbon except for compounds having a simple structure, such as carbon monoxide and carbon dioxide. The material including the organic compound can be easily formed by a wet coating method.

In each example, the following inequality (1) may be satisfied:

$$1.10 \leq n 3 \leq 1.28 \qquad ( 1 )$$

where a reference wavelength λ is 550 nm and n3 is a refractive index of the thin film layer 03 for the wavelength of 550 mn.

In each example, n1 is a refractive index of the thin film layer 01 for the wavelength of 550 mn, n2 is a refractive index of the thin film layer 02 for the wavelength of 550 mn, and n3 is the refractive index of the thin film layer 03 for the wavelength of 550 mn. d1 (nm) is a physical thickness of the thin film layer 01, d2 (nm) is a physical thickness of the thin film layer 02, and d3 (nm) is a physical thickness of the thin film layer 03. Then, the following inequalities (2) to (8) may be satisfied:

$$1.3 \leq n 1 \leq 1.5 \qquad ( 2 )$$

$$1.56 \leq n 2 \leq 1.7 \qquad ( 3 )$$

$$1.1 \leq n 3 \leq 1.28 \qquad ( 4 )$$

$$10 \leq n 1 d 1 \leq 155 \qquad ( 5 )$$

$$10 \leq n 2 d 2 \leq 155 \qquad ( 6 )$$

$$100 \leq n 3 d 3 \leq 155 \qquad ( 7 )$$

$$200 \leq n 1 d 1 + n 2 d 2 + n 3 d 3 \leq 300 \qquad ( 8 )$$

Sufficient antireflection performance cannot be obtained in a case where the refractive index or physical thickness of each material is outside the ranges of inequalities (2) to (8).

Inequality (1) or (4) may be replaced with inequality (9) below:

$$1.12 \leq n 3 \leq 1.22 \qquad ( 9 )$$

Inequality (1) or (4) may be replaced with inequality (9a) below:

$$1.15 \leq n 3 \leq 1.2 \qquad ( 9 a )$$

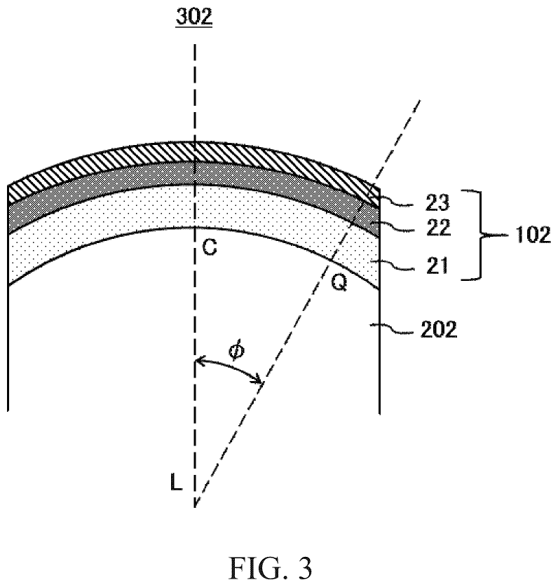

Referring now to FIGS. 2 and 3, a description will be given of the optical element 300 (301, 302) in which the antireflection film 100 (101, 102) is formed on the transparent substrate 200 (201, 202). FIG. 2 is a schematic sectional view of the optical element 301 according to Examples 1, 2, 5, 7, 8, 11, and 13 and comparative examples 1 and 2 to be described below. FIG. 3 is a schematic sectional view of the optical element 302 according to each of Examples 3, 4, 6, 9, 10, 12, and 14 to be described below.

In the optical element 301 illustrated in FIG. 2, the transparent substrate 201 has a concave surface shape on which an antireflection film 101 consisting of a thin film layer (first layer) 11, a thin film layer (second layer) 12, and a thin film layer (third layer) 13 is formed. In the optical element 302 illustrated in FIG. 3, the transparent substrate 202 has a convex surface shape on which an antireflection film 102 consisting of a thin film layer (first layer) 21, a thin film layer (second layer) 22, and a thin film layer (third layer) 23 is formed. A description will now be given of the optical element 301 illustrated in FIG. 2 but is similarly applicable to the optical element 302 illustrated in FIG. 3.

An optical surface of the optical element 301 for forming the antireflection film 101 has a shape with a rotational symmetry axis (e.g., a reference axis; for example, a surface normal passing through an origin (e.g., surface vertex)), in other words, a rotationally symmetric shape. However, each example is not limited to this implementation, and the optical surface for forming the antireflection film 101 may have no rotational symmetry, for example, a partially notched shape of the rotationally symmetric shape. In FIG. 2, position C is a rotational center of a lens surface of the transparent substrate 201 on which the antireflection film 101 is provided. In other words, position C is a position (e.g., intersection) where the rotational symmetry axis (e.g., reference axis, optical axis L) of the lens surface intersects the lens surface of the transparent substrate 201. position Q is located at a place farthest from position C in an optical effective area on the lens surface of the transparent substrate 201. The optical effective area is an area (e.g., effective diameter) on the optical surface, through which an effective light beam that contributes to imaging passes.

Where ϕ is an angle (hereinafter referred to as a half open angle) between the optical axis L and the normal at position Q, the half open angle ϕ has a maximum value in the optical effective area. The antireflection film 101 consists of the thin film layers 11, 12, and 13 in order from the transparent substrate 201. At position C, d1c (nm) is a physical thickness of the thin film layer 11, d2c (mm) is a physical thickness of the thin film layer 12, and d3c (nm) is a physical thickness of the thin film layer 13. At position Q, d1q (nm) is a physical thickness of the thin film layer 11, d2q (nm) is a physical thickness of the thin film layer 12, and d3q (nm) is a physical thickness of the thin film layer 13. In this case, the following inequalities (10) to (12) may be satisfied:

$$1. < d 1 q / d 1 c \leq 1.3 \qquad ( 10 )$$

$$1. < d 2 q / d 2 c \leq 1.3 \qquad ( 11 )$$

$$1. < d 3 q / d 3 c \leq 1.3 \qquad ( 12 )$$

In each example, each of the film thicknesses of the thin film layers 11, 12, and 13 constituting the antireflection film 101 may be smallest at position C as the center (e.g., optical axis center) of the antireflection film 101 and become larger as a position separates from the optical axis center.

In each example, the half open angle ϕ (°) at position Q may satisfy the following inequality (13):

$$ϕ \geq 25 \qquad ( 13 )$$

The thin film layers 03, 13, and 23 may have voids. The void, in other words, air having a refractive index of 1.0 can reduce the refractive index to ranges in which inequalities (1), (4), and (9) are satisfied. In a case where the refractive indices are smaller than 1.10, a ratio of voids included in the layers is high, and thus the film strength becomes low. In a case where the refractive indices are larger than 1.30, sufficient antireflection performance cannot be obtained. An antifouling film or the like may be provided on the surface of the antireflection film according to each example (e.g., surfaces of the thin film layers 03, 13, and 23), if necessary. Examples of the antifouling film includes a film containing fluorine polymer, fluorosilane monomolecular, titanium oxide particles, or the like.

In each example, the thin film layers 03, 13, and 23 may be made of solid particles, chain particles, or hollow particles. The thin film layers 03, 13, and 23 may be made of hollow particles having a void inside. The void may be a single hole or multiple holes, which can be selected as appropriate. The material of solid particles, chain particles, or hollow particles may have a low refractive index. The material is, for example, organic resin made of SiO2, MgF2, fluorine, or silicon, but SiO2, but particles of which can be easily manufactured may be used. The average particle diameter of the hollow particle may be equal to or larger than 15 nm and equal to or smaller than 100 nm, or may be equal to or larger than 15 nm and equal to or smaller than 80 nm. In a case where the average particle diameter of the hollow particle is smaller than 15 nm, it is difficult to reliably produce a particle as a core. In a case where the average particle diameter of the hollow particle is larger than 100 nm, the size of a void between particles becomes large, and thus a large void is likely to occur and scattering along with the particle size may occur.

The thin film layers 01, 11, and 21 may be made of a material including solid particles bound with a binder such as a siloxane bond, in particular, solid silica particles. Alternatively, the material may include acrylic resin as “acrylic acid ester or methacrylic acid ester polymer”.

The thin film layers 02, 12, and 22 may be made of a material including polyimide resin, which is a “polymer compound containing an imide (—CO—NR—CO—) bond”. Alternatively, the thin film layers may be made of a material including epoxy resin that is “resin crosslinked and cured with an epoxy group having oxacyclopropane (oxirane) as three-membered cyclic ether in a structural formula”.

In each example, the optical element 300 is manufactured by forming the thin film layer 01 on the transparent substrate 200, forming the thin film layer 02 on the thin film layer 01, and forming the thin film layer 03 on the thin film layer 02. In each example, the thin film layers 01, 11, and 21, the thin film layers 02, 12, and 22, and the thin film layers 03, 13, and 23 may be formed by a wet film forming method that involves applying application solution containing a film material, followed by drying and calcining. The wet film forming method can inexpensively perform application of a large area. In particular, a spin coat method may be used because this method can flatten in-plane film thickness distribution by performing application while performing rotation about the rotational axis of an application surface. A dry film forming method such as an evaporation method or a sputter method forms a film in a positional relationship in which an evaporation source and a central part of a lens face each other. In a large open angle lens, an incident angle of an evaporation material on a lens surface is large at a peripheral part, and thus a film thickness at the peripheral part is smaller than that at a central part. Thus, film (thickness) unevenness occurs in the lens surface, and the antireflection performance is biased. To form a film without (thickness) unevenness, a mask is to be provided or a substrate position and rotation operation are to be controlled.

An organic solvent that can be used for the application solution is not particularly limited as long as application easiness, performance, and the like are not degraded, but may use any well-known solvent. For example, the organic solvent may include monohydric alcohols such as methanol, ethanol, 1-propanol, 2-propanol, 1-butanol, 2-butanol, 2-methylpropanol, 1-pentanol, and 2-pentanol, cyclopentanol, and 2-methylbutanol. The organic solvent may include 3-methylbutanol, 1-hexanol, 2-hexanol, 3-hexanol, 4-methyl-2-pentanol, 2-methyl-1-pentanol, or 2-ethylbutanol. The organic solvent may include 2,4-dimethyl-3-pentanol, 3-ethylbutanol, 1-heptanol, 2-heptanol, 1-octanol, or 2-octanol. The organic solvent may include polyhydric alcohol such as ethylene glycol and triethylene glycol.

The organic solvent may include ether alcohols such as methoxyethanol, ethoxylethanol, propoxyethanol, iso-propoxyethanol, butoxyethanol, 1-methoxy-2-propanol, 1-ethoxyl-2-propanol, and 1-propoxy-2-propanol. The organic solvent may include ethers such as dimethoxyethane, diglyme, tetrahydrofuran, dioxane, diisopropyl ether, dibutyl ether, and cyclopentyl methyl ether. The organic solvent may include esters, such as formic acid ethyl, ethyl acetate, acetic acid n-butyl, lactic acid methyl, lactic acid ethyl, ethylene glycol monomethyl ether acetate, ethylene glycol monoethyl ether acetate, ethylene glycol monobutyl ether acetate, and propylene glycol monomethyl ether acetate.

The organic solvent may include various aliphatic or cycloaliphatic hydrocarbons such as n-hexane, n-octane, cyclohexane, cyclopentane, and cyclooctane. The organic solvent may include various aromatic hydrocarbons such as toluene, xylene, and ethyl benzene. The organic solvent may include various ketones such as acetone, methyl ethyl ketone, methyl iso butyl ketone, cyclopentanone, and cyclohexanone. The organic solvent may include various chlorinated hydrocarbons such as chloroform, methylene chloride, carbon tetrachloride, and tetra chloroauric ethane. The organic solvent may include non-protonic polar solvents such as N-methyl pyrrolidone, N,N-dimethylformamide, N,N-dimethylacetamide, and ethylene carbonate. Among these solvents, two or more kinds of solvents may be used in mixture.

In a case where solid particles, chain particles, or hollow particles are used for the thin film layers 03, 13, and 23 and solid particles are used for the thin film layers 01, 11, and 21, a binder for binding may be used to improve the strength. The binder may be a siloxane bond, particularly in a case where silica particles with abundant hydroxyl groups are used on the surface.

In each example, the thin film layers 01 and 11, the thin film layers 02 and 12, and the thin film layers 03 and 13 are made of a material that can be formed by the wet film forming method, and thus the material or the binder includes an organic compound. Moreover, the antireflection film according to each example is not calcined at a high temperature in the process of drying after application. Thus, for example, plastic and optical curable resin, which are prone to thermal deformation, can be used for the transparent substrates 200, 201, and 202.

The following inequality (14) may be satisfied:

$$1.45 \leq n S \leq 2.10 \qquad ( 14 )$$

where nS is refractive indices of the transparent substrates 200, 201, and 202.

Specific examples will be described below. These examples are merely illustrative and this disclosure is not limited to a range of each example.

### Example 1

First, Example 1 will now be described. FIG. 2 is a schematic sectional view of an optical element 301 according to this example. The optical element 301 according to this example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including solid silica as a primary component, the thin film layer 12 is made of a material including polyimide resin as a primary component, and the thin film layer 13 is made of a material including hollow silica as a primary component. Table 1 lists details of the film configuration of the optical element 301 according to this example. The refractive indices and film thicknesses of the materials satisfy inequalities (1) to (8) and (10) to (12). Each of the thin film layers 11, 12, and 13 includes an organic compound.

The antireflection film 101 according to this example is formed by the following method.

### Hollow Silica Application Solution 1

Isopropyl alcohol dispersion solution of hollow silica particles (THRULYA 4110 manufactured by JGC Catalysts and Chemicals Ltd.; average particle diameter of 60 nm approximately, shell thickness of approximately 12 nm, solid content concentration 20.5 of wt % (mass percent)) of 580 g is used. The isopropyl alcohol dispersion solution is heated to distill away isopropyl alcohol while 1-ethoxyl-2-propanol (hereinafter abbreviated as 1E2P) is added. The isopropyl alcohol is distilled away to the solid content concentration of 19.5 wt % to prepare 1E2P solvent replacement solution (hereinafter referred to as solvent replacement 1) of hollow silica particle of 610 g. Organic acid including fluorine is added to the solvent replacement solution 1 thus obtained so that a component ratio of hollow silica particle and organic acid including fluorine (trifluoroacetic acid with three fluorine atoms manufactured by Tokyo Chemical Industry Co., Ltd.) becomes 100/1, and thereby hollow particle dispersion solution 1 is obtained.

Phosphine acid of 3.6 g, 1-propoxy-2-propanol of 11.4 g, and methyl polysilicate (methyl silicate 53A manufactured by Colcoat Co, .Ltd.) of 4.5 g, which are diluted to the concentration of 0.1% in pure water are slowly added to another container and agitated for 120 minutes at room temperature. Thereby, silica sol (hereinafter referred to as silica sol 1) with a solid content concentration of 12 wt % is prepared.

The hollow particle dispersion solution 1 is diluted with lactic acid ethyl so that the solid content concentration becomes 4.5 wt %, and then the silica sol 1 is added so that a component ratio of hollow silica particle and silica sol becomes 100/12. Through the subsequent agitation in mixture for two hours at room temperature, hollow silica application solution 1 including hollow silica particle is obtained.

### Solid Silica Application Solution 1

Solid silica application solution 1 is produced by adding 1-methoxy-2-propanol of 300 g and the silica sol 1 of 4 g to silica particle dispersion solution PL-1 (manufactured by FUSO CHEMICAL CO., LTD.) of 25 g.

### Polyimide Application Solution 1

Hexane is gradually added to 4,4′-methylene bis (amino cyclohexane) (hereinafter referred to as DADCM; manufactured by Tokyo Chemical Industry Co., Ltd.) of 200 g while being refluxed until completely dissolved. After heating is stopped and the solution is left to stand at room temperature for several days, precipitate is filtered and dried under reduced pressure. White solid cyclic diamine DADCM of 58 g refined in this manner is obtained.

Three kinds of diamine of 12 mmol in total are dissolved in N, N-dimethylacetamide (hereinafter abbreviated as DMAc) to produce diamine solution. One of the three kinds of diamine is cyclic diamine DADCM. The other two are aromatic diamine 4,4′-bis(4-aminophenoxy)biphyenyl (product name BODA; manufactured by Wakayama Seika Kogyo Co., Ltd.) and siloxane-containing diamine 1,3-bis(3-aminopropyl)tetramethyl disiloxane (product name PAM-E; manufactured by Shin-Etsu Chemical Co., Ltd.).

Acid anhydride of 12 mmol approximately is added to the diamine solution being water-cooled. The acid anhydride is 4-(2,5-dioxotetrahydrofuran-3-yl)-1,2,3,4-tetrahydronaphthalene-1,2-dicarboxylic acid anhydride (product name TDA-100; manufactured by New Japan Chemical Co., Ltd.). Alternatively, the acid anhydride is 5-(2,5-dioxotetrahydrofuryl)-3-methyl-3-cyclohexene-1,2-dicarboxylic acid anhydride (product name B-4400; manufactured by DIC). The amount of DMAc is adjusted so that the mass total of diamine and acid anhydride is 20 weight %.

The solution is agitated at room temperature for 15 hours to carry out polymerization reaction. In addition, the solution is adjusted to 8 weight % through dilution with DMAc and then agitated at room temperature for one hour with addition of pyridine of 7.4 ml and acetic anhydride of 3.8 ml. The solution is further agitated for 4 hours while being heated in an oil bath from 60 to 70° C. Polymer is re-precipitated from the polymerization solution with methanol or methanol and then washed in methanol several times. After drying at 60° C. for 24 hours, white to light-yellow powder of polyimide 1 is obtained.

The obtained polyimide 1 is dissolved in cyclohexanone so that the solid content concentration becomes 2.5 wt %, and the polyimide application solution 1 is produced.

The antireflection film 101 is formed with the solid silica application solution 1, the polyimide application solution 1, and the hollow silica application solution 1.

The solid silica application solution 1 of 0.2 ml is dropped on the lens surface of the transparent substrate 201 and spin-coated at 4000 rpm for 20 seconds. Next, the polyimide application solution 1 of 0.2 ml is continuously dropped on the lens surface of the transparent substrate 201 and spin-coated at 4000 rpm for 20 seconds. In addition, the hollow silica application solution 1 of 0.2 ml is dropped on the lens surface of the transparent substrate 201 and spin-coated at 4000 rpm for 20 seconds. Thereafter, drying is performed in a clean room at room temperature of 23° C. for 24 hours or longer.

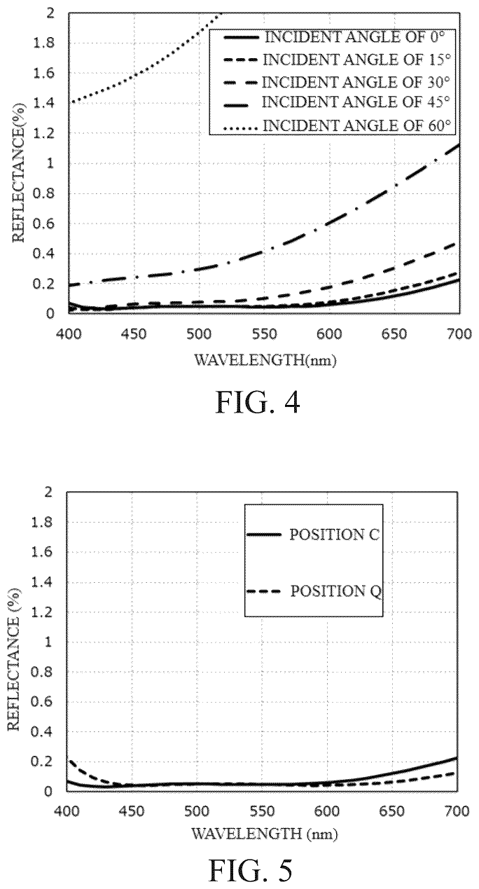

FIG. 4 illustrates the reflectance characteristic of the optical element 301 according to this example at the incident angles of 0°, 15°, 30°, 45°, and 60° at position C. In FIG. 4, the horizontal axis represents wavelength (nm), and the vertical axis represents reflectance (%). This is similarly applicable to other reflectance characteristic diagrams. The reflectance is equal to or smaller than 0.2% for light in a wavelength band of 420 nm to 680 nm at an incident angle of 0°, and it can be understood that the reflectance characteristic is extremely favorable. FIG. 5 illustrates the reflectance characteristic of the optical element 301 according to this example at the incident angle of 0° at positions C and Q. According to Table 1, the film thickness of each thin film layer at position Q is larger than that at position C by approximately 6%, but it can be confirmed that the reflectance characteristic is equal to or smaller than 0.2% for light in a wavelength band of 420 nm to 680 nm and is excellent.

TABLE 1

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 112.5 | 119.8 |
| FILM 101 | LAYER 13 | | | | |
| | THIN FILM | POLYIMIDE RESIN | 1.62 | 25.3 | 26.7 |
| | LAYER 12 | | | | |
| | THIN FILM | SOLID SILICA | 1.35 | 33.7 | 35.5 |
| | LAYER 11 | | | | |
| TRANSPARENT | | S-TIL26 | 1.57 | — | — |
| SUBSTRATE 201 | | | | | |

### Example 2

Example 2 will now be described. FIG. 2 is a schematic sectional view of an optical element 301 according to this example. The optical element 301 according to this example is an optical element in which an antireflection film 101 is formed on a transparent substrate 201. The transparent substrate 201 is S-LAL12 (manufactured by OHARA INC.) having a refractive index of 1.68 (for light with a wavelength of 550 nm). The lens surface of the transparent substrate 201 on which the antireflection film 101 is formed has a concave surface shape. The half open angle ϕ at position Q on the maximum ray effective diameter is 70°. As for layer materials, the thin film layer 11 is made of a material including solid silica as a primary component, the thin film layer 12 is made of a material including polyimide resin as a primary component, and the thin film layer 13 is made of a material including hollow silica as a primary component. Table 2 lists details of the film configuration of the optical element 301 according to this example. The refractive indices and film thicknesses of the materials satisfy inequalities (1) to (8) and (10) to (12). Each of the thin film layers 11, 12, and 13 includes an organic compound.

The antireflection film 101 according to this example is formed by the following method.

### Hollow Silica Application Solution 2

The hollow particle dispersion solution 1 and the silica sol 1 are produced a method similar to that of the hollow particle application solution 1. The hollow particle dispersion solution 1 is diluted with lactic acid ethyl so that the solid content concentration becomes 4.5 wt %, and then the silica sol 1 is added so that a component ratio of hollow silica particle and silica sol becomes 100/9. Through subsequent agitation in mixture for two hours at room temperature, hollow silica application solution 2 including hollow silica particle is obtained. The antireflection film 101 is formed with the solid silica application solution 1, the polyimide application solution 1, and the hollow silica application solution 2.

The solid silica application solution 1 of 0.2 ml is dropped on the lens surface of the transparent substrate 201 and spin-coated at 4000 rpm for 20 seconds. Next, the polyimide application solution 1 of 0.2 ml is continuously dropped on the lens surface of the transparent substrate 201 and spin-coated at 4000 rpm for 20 seconds. In addition, the hollow silica application solution 2 of 0.2 ml is dropped on the lens surface of the transparent substrate 201 and spin-coated at 4000 rpm for 20 seconds. Thereafter, drying is performed in a clean room at room temperature of 23° C. for 24 hours or longer.

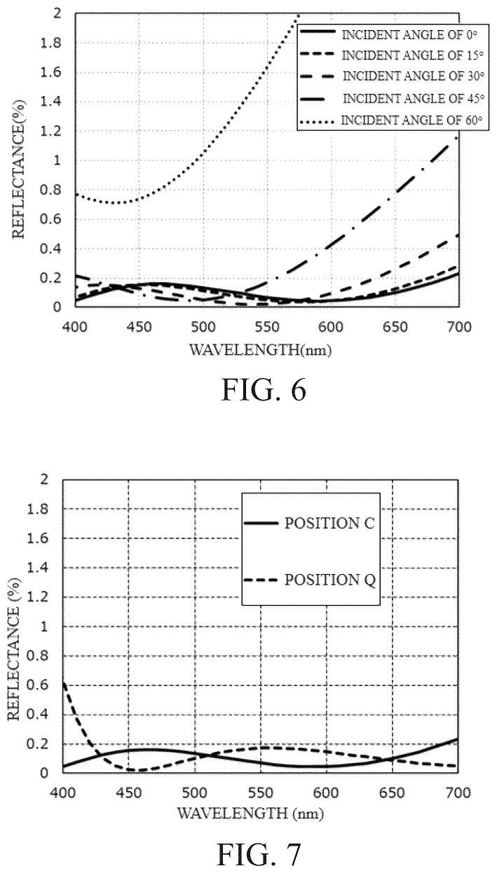

FIG. 6 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 7 illustrates the reflectance characteristic of the optical element 301 according to this example at the incident angle of 0° at positions C and Q. According to Table 2, the film thickness of each thin film layer at position Q is larger than that at position C by 20%, but it can be confirmed that the reflectance characteristic is equal to or smaller than 0.2% for light in a wavelength band of 420 nm to 680 nm and is excellent.

TABLE 2

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.14 | 112.22 | 135.0 |
| FILM 101 | LAYER 13 | | | | |
| | THIN FILM | POLYIMIDE RESIN | 1.62 | 19.23 | 23.1 |
| | LAYER 12 | | | | |
| | THIN FILM | SOLID SILICA | 1.35 | 44.33 | 53.3 |
| | LAYER 11 | | | | |
| TRANSPARENT | | S-LAL12 | 1.68 | — | — |
| SUBSTRATE 201 | | | | | |

### Example 3

Example 3 will now be described. FIG. 3 is a schematic sectional view of an optical element 302 according to this example. The optical element 302 according to this example is an optical element in which an antireflection film 102 is formed on a transparent substrate 202. The transparent substrate 202 is S-LAH53 (manufactured by OHARA INC.) having a refractive index of 1.81 (for light with a wavelength of 550 nm). The lens surface of the transparent substrate 202 on which the antireflection film 102 is formed has a convex surface shape. The half open angle ϕ at position Q on the maximum ray effective diameter is 30°. As for layer materials, the thin film layer 21 is made of a material including acrylic resin as a primary component, and the thin film layer 22 is made of a material including hollow silica as a primary component. Table 3 lists details of the film configuration of the optical element 302 according to this example. The refractive indices and film thicknesses of the materials satisfy inequalities (1) to (8) and (10) to (12). Each of the thin film layers 21, 22, and 23 includes an organic compound.

The antireflection film 102 according to this example is formed by the following method.

### Chain Silica Application Solution 1

An evaporator is used to replace, with 1-propoxy-2-propanol (manufactured by SIGMA Corporation), 2-propanol in 2-propanol (IPA) dispersion solution (IPA-ST-UP manufactured by Nissan Chemical Corporation; average particle size of 12 nm, solid content concentration of 15 wt %) of chain silica particle. Thereby, 1-propoxy-2-propanol dispersion solution (solid content concentration 17 of wt %) is produced. This will be referred to as dispersion solution 2. Next, tetraethoxysilane (TEOS; manufactured by Tokyo Chemical Industry Co., Ltd.) of 18.5 g is added to catalyst water as 10 equivalents of 0.1 wt % phosphine acid of 16.0 g relative to TEOS and mixed and agitated in a water bath at 20° C. for 60 minutes, and binder solution 2 is obtained.

The binder solution 2 of 33.4 g is added to the dispersion solution 2 of 251.3 g. Thereafter, 1-propoxy-2-propanol of 174.5 g and lactic acid ethyl of 546.5 g are added and agitated for 60 minutes, and chain silica application solution 1 is obtained.

### Acrylic Application Solution

N-cyclohexyl maleimide (hereinafter referred to as CHMI) of 6.1 g and 2,2,2-trifluoroethyl methacrylate (product name M-3F; manufactured by kyoeisha Chemical Co., Ltd.) of 4.0 g are used. Further, 3-(methacryloyloxy) propyltrimethoxysilane (product name LS-3380; manufactured by Shin-Etsu Chemical Co., Ltd.) of 0.45 g is used. In addition, 2,2′-azobis (iso butyronitrile) (hereinafter referred to as AIBN) of 0.08 g is used. These are agitated and dissolved in toluene of 24.8 g to obtain solution. The solution is repeatedly degassed and nitrogen-purged while cooling with ice water, and then is agitated under nitrogen flow at 60 to 70° C. for seven hours. Polymerization solution is slowly input into strongly agitated methanol, and polymer thus precipitated is filtered and then agitated and washed in methanol for several times. The polymer collected by filtering is dried in a vacuum at 80° C. to 90° C. White-powder maleimide copolymer of 8.3 g (yield of 81%) with the maleimide copolymerization ratio of 0.57 is obtained. Powder of maleimide copolymer 1 of 2.2 g is dissolved in cyclopentanone/cyclohexanone mixed solvent of 97.8 g to prepare solution of the maleimide copolymer 1, and acrylic application solution is produced.

### Polyimide Application Solution 2

White solid cyclic diamine DADCM of 50 g is obtained by refining 4,4′-methylene bis (amino cyclohexane) (hereinafter referred to as DADCM; manufactured by Tokyo Chemical Industry Co., Ltd.). Three kinds of diamine of 12 mmol in total are dissolved in N,N-dimethylacetamide (hereinafter abbreviated as DMAc). One of the three kinds of diamine is cyclic diamine DADCM. The other two are aromatic diamine 4,4′-bis(4-aminophenoxy)biphyenyl (product name BODA; manufactured by Wakayama Seika Kogyo Co., Ltd.) and siloxane-containing diamine 1,3-bis(3-aminopropyl)tetramethyl disiloxane (product name PAM-E; manufactured by Shin-Etsu Chemical Co., Ltd.).

The following method is similar to that for the polyimide application solution 1. Polyimide 2 with a different ratio of the three kinds of diamine from that for the polyimide application solution 1 is obtained. The obtained polyimide 2 is dissolved in cyclohexanone so that the solid content concentration becomes 2.5 wt %, and polyimide application solution 2 is produced.

The antireflection film 102 is formed with the acrylic application solution, the polyimide application solution 2, and the chain silica application solution 1.

The acrylic application solution of 0.2 ml is dropped on the lens surface of the transparent substrate 202 and spin-coated at 4000 rpm for 20 seconds. Next, the polyimide application solution 2 of 0.2 ml is continuously dropped on the lens surface of the transparent substrate 202 and spin-coated at 4000 rpm for 20 seconds. In addition, the chain silica application solution 1 of 0.2 ml is dropped on the lens surface of the transparent substrate 202 and spin-coated at 4000 rpm for 20 seconds. Thereafter, drying is performed in a clean room at room temperature of 23° C. for 24 hours or longer.

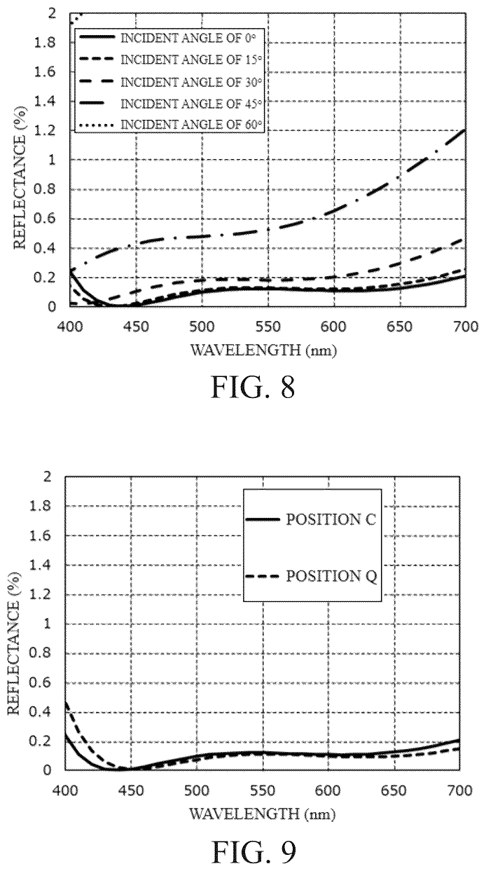

FIG. 8 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 9 illustrates the reflectance characteristic of the optical element 302 according to this example at the incident angle of 0° at positions C and Q. According to Table 3, the film thickness of each thin film layer at position Q is larger than that at position C by approximately 2%, but it can be confirmed that the reflectance characteristic is equal to or smaller than 0.2% for light in a wavelength band of 420 nm to 680 nm and is excellent.

TABLE 3

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | CHAIN SILICA | 1.24 | 106.6 | 110.3 |
| FILM 102 | LAYER 23 | | | | |
| | THIN FILM | POLYIMIDE RESIN | 1.68 | 45.4 | 46.3 |
| | LAYER 22 | | | | |
| | THIN FILM | ACRYLIC RESIN | 1.45 | 22.1 | 22.6 |
| | LAYER 21 | | | | |
| TRANSPARENT | | S-LAH53 | 1.81 | — | — |
| SUBSTRATE 202 | | | | | |

### Example 4

Example 4 will now be described. FIG. 3 is a schematic sectional view of an optical element 302 according to this example. The optical element 302 according to this example is an optical element in which an antireflection film 102 is formed on a transparent substrate 202. The transparent substrate 202 is S-LAH79 (manufactured by OHARA INC.) having a refractive index of 2.00 (for light with a wavelength of 550 nm). The lens surface of the transparent substrate 202 on which the antireflection film 102 is formed has a convex surface shape. The half open angle ϕ at position Q on the maximum ray effective diameter is 45°. As for layer materials, the thin film layer 11 is made of a material including solid silica as a primary component, the thin film layer 12 is made of a material including polyimide resin as a primary component, and the thin film layer 13 is made of a material including hollow silica as a primary component. Table 4 lists details of the film configuration of the optical element according to this example. The refractive indices and film thicknesses of the materials satisfy inequalities (1) to (8) and (10) to (12). Each of the thin film layers 21, 22, and 23 includes an organic compound.

The antireflection film 102 according to this example is formed by the following method.

The antireflection film 102 is formed with the solid silica application solution 2, the polyimide application solution 2, and the hollow silica application solution 1.

The solid silica application solution 2 of 0.2 ml is dropped on the lens surface of the transparent substrate 202 and spin-coated at 4000 rpm for 20 seconds. Next, the polyimide application solution 2 of 0.2 ml is dropped on the lens surface of the transparent substrate 202 and spin-coated at 4000 rpm for 20 seconds. In addition, the hollow silica application solution 1 of 0.2 ml is dropped on the lens surface of the transparent substrate 202 and spin-coated at 4000 rpm for 20 seconds. Thereafter, drying is performed in a clean room at room temperature of 23° C. for 24 hours or longer.

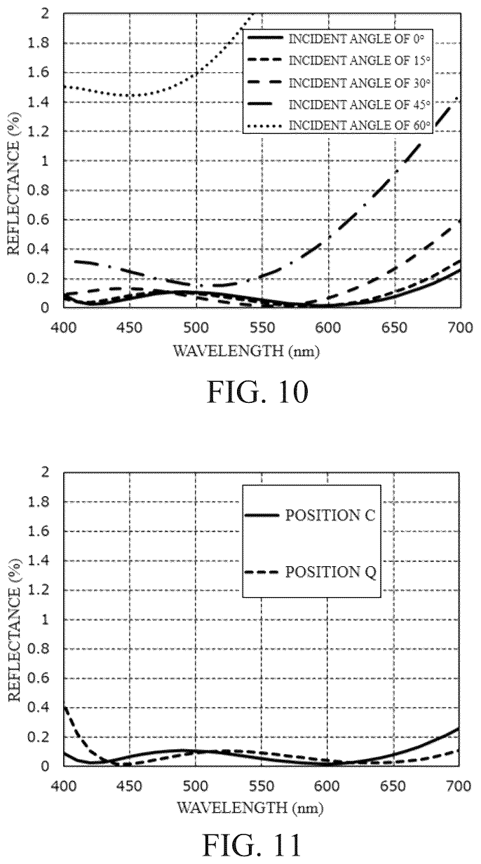

FIG. 10 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 11 illustrates the reflectance characteristic of the optical element 302 according to this example at the incident angle of 0° at positions C and Q. According to Table 4, the film thickness of each thin film layer at position Q is larger than that at position C by approximately 6%, but it can be confirmed that the reflectance characteristic is equal to or smaller than 0.2% for light in a wavelength band of 420 nm to 680 nm and is excellent.

TABLE 4

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 106.5 | 113.4 |
| FILM 102 | LAYER 23 | | | | |
| | THIN FILM | POLYIMIDE RESIN | 1.68 | 51.4 | 54.3 |
| | LAYER 22 | | | | |
| | THIN FILM | SOLID SILICA | 1.35 | 14.2 | 15.0 |
| | LAYER 21 | | | | |
| TRANSPARENT | | S-LAH79 | 2.00 | — | — |
| SUBSTRATE 202 | | | | | |

### Example 5

Example 5 will now be described. FIG. 2 is a schematic sectional view of an optical element 301 according to this example. The optical element 301 according to this example is an optical element in which an antireflection film 101 is formed on a transparent substrate 201. The transparent substrate 201 is S-LAH53 (manufactured by OHARA INC.) having a refractive index of 1.81 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including acrylic resin as a primary component, the thin film layer 12 is made of a material including polyimide resin as a primary component, and the thin film layer 13 is made of a material including hollow silica as a primary component. Table 5 lists details of the film configuration of the optical element according to this example. The refractive indices and film thicknesses of the materials satisfy inequalities (1) to (8) and (10) to (12). Each of the thin film layers 11, 12, and 13 includes an organic compound.

The antireflection film 101 according to this example is formed by the following method.

The antireflection film 101 is formed with the acrylic application solution, the polyimide application solution 1, and the hollow silica application solution 2. The acrylic application solution of 0.2 ml is dropped on the lens surface of the transparent substrate 201 and spin-coated at 4000 rpm for 20 seconds. Next, the polyimide application solution 1 of 0.2 ml is dropped on the lens surface of the transparent substrate 201 and spin-coated at 4000 rpm for 20 seconds. In addition, the hollow silica application solution 2 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

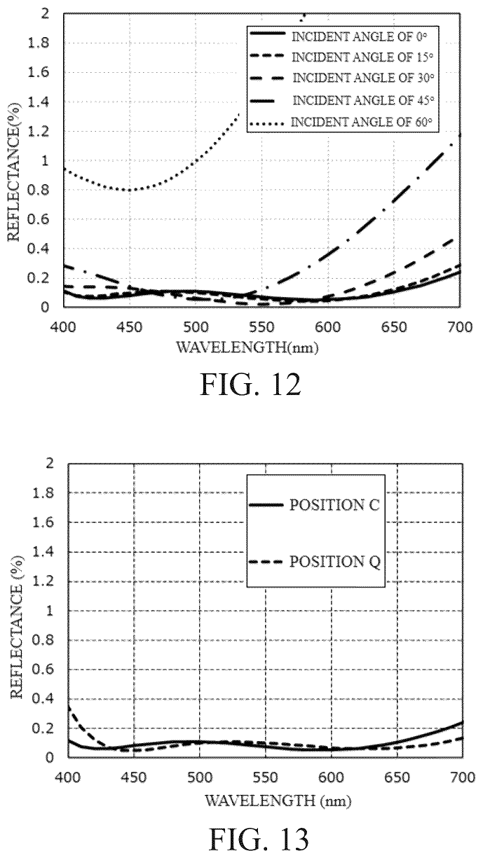

FIG. 12 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 13 illustrates the reflectance characteristic of the optical element 301 according to this example at the incident angle of 0° at positions C and Q. According to Table 5, the film thickness of each thin film layer at position Q is larger than that at position C by approximately 6%, but it can be confirmed that the reflectance characteristic is equal to or smaller than 0.2% for light in a wavelength band of 420 nm to 680 nm and is excellent.

TABLE 5

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.14 | 114.3 | 121.8 |
| FILM 101 | LAYER 13 | | | | |
| | THIN FILM | POLYIMIDE RESIN | 1.62 | 20.9 | 22.1 |
| | LAYER 12 | | | | |
| | THIN FILM | ACRYLIC RESIN | 1.45 | 51.8 | 54.7 |
| | LAYER 11 | | | | |
| TRANSPARENT | | S-LAHS3 | 1.81 | — | — |
| SUBSTRATE 201 | | | | | |

### Example 6

Example 6 will now be described. FIG. 3 is a schematic sectional view of an optical element 302 according to this example. The optical element 302 according to this example is an optical element in which an antireflection film 102 is formed on a transparent substrate 202. The transparent substrate 202 is S-LAH66 (manufactured by OHARA INC.) having a refractive index of 1.77 (for light with a wavelength of 550 nm). The lens surface of the transparent substrate 202 on which the antireflection film 102 is formed has a convex surface shape. The half open angle ϕ at position Q on the maximum ray effective diameter is 60°. As for layer materials, the thin film layer 21 is made of a material including solid silica as a primary component, the thin film layer 22 is made of a material including epoxy resin as a primary component, and the thin film layer 23 is made of a material including hollow silica as a primary component. Table 6 lists details of the film configuration of the optical element 302 according to this example. The refractive indices and film thicknesses of the materials satisfy inequalities (1) to (8) and (10) to (12). Each of the thin film layers 21, 22, and 23 includes an organic compound.

The antireflection film 102 according to this example is formed by the following method.

### Epoxy Application Solution

Intermediate layer application solution 3 is produced by adding 1-methoxy-2-propanol of 500 g to epoxy resin jER828 (manufactured by Mitsubishi Chemical Corporation) of 25 g. The antireflection film 102 is formed with the solid silica application solution 2, the epoxy application solution, and the hollow silica application solution 1.

The solid silica application solution 2 of 0.2 ml is dropped on the lens surface of the transparent substrate 202 and spin-coated at 4000 rpm for 20 seconds. Next, the epoxy application solution of 0.2 ml is dropped on the lens surface of the transparent substrate 202 and spin-coated at 4000 rpm for 20 seconds. In addition, the hollow silica application solution 1 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

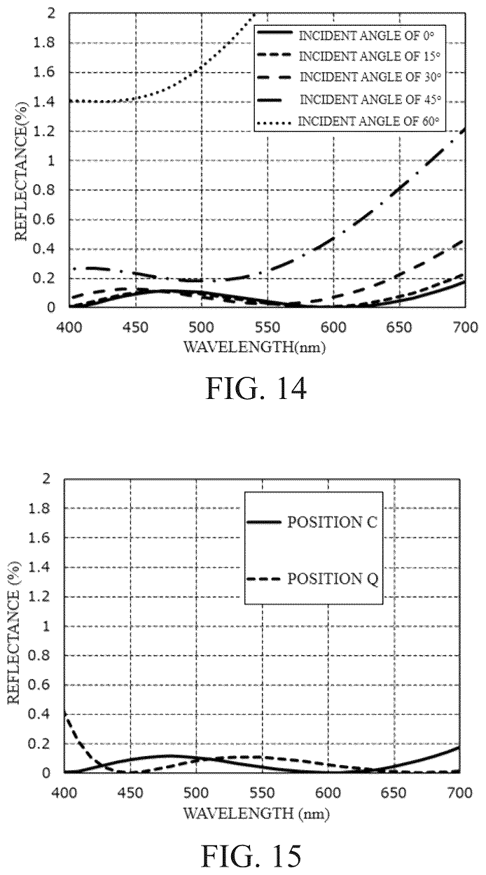

FIG. 14 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 15 illustrates the reflectance characteristic of the optical element 302 according to this example at the incident angle of 0° at positions C and Q. According to Table 6, the film thickness of each thin film layer at position Q is larger than that at position C by approximately 12%, but it can be confirmed that the reflectance characteristic is equal to or smaller than 0.2% for light in a wavelength band of 420 nm to 680 nm and is excellent.

TABLE 6

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 105.0 | 117.3 |
| FILM 102 | LAYER 23 | | | | |
| | THIN FILM | EPOXY RESIN | 1.58 | 48.1 | 54.1 |
| | LAYER 22 | | | | |
| | THIN FILM | SOLID SILICA | 1.38 | 18.8 | 21.2 |
| | LAYER 21 | | | | |
| TRANSPARENT | | S-LAH66 | 1.77 | — | — |
| SUBSTRATE 202 | | | | | |

### Example 7

Example 7 will now be described. FIG. 2 is a schematic sectional view of an optical element 301 according to this example. The optical element 301 according to this example is an optical element in which an antireflection film 101 is formed on a transparent substrate 201. The transparent substrate 201 is ZEONEX K22R (manufactured by Japan Zeon Corporation) having a refractive index of 1.54 (for light with a wavelength of 550 nm). The lens surface of the transparent substrate 201 on which the antireflection film 101 is formed has a concave surface shape. The half open angle ϕ at position Q on the maximum ray effective diameter is 30°. As for layer materials, the thin film layer 11 is made of a material including solid silica as a primary component, the thin film layer 12 is made of a material including polyimide resin as a primary component, and the thin film layer 13 is made of a material including hollow silica as a primary component. Table 7 lists details of the film configuration of the optical element 301 according to this example. The refractive indices and film thicknesses of the materials satisfy inequalities (1) to (8) and (10) to (12). Each of the thin film layers 11, 12, and 13 includes an organic compound.

The antireflection film 101 according to this example is formed by the following method.

The antireflection film 101 is formed with the solid silica application solution 1, the polyimide application solution 1, and the hollow silica application solution 1. The solid silica application solution 1 of 0.2 ml is dropped on the lens surface of the transparent substrate 201 and spin-coated at 4000 rpm for 20 seconds. Next, the polyimide application solution 1 of 0.2 ml is dropped on the lens surface of the transparent substrate 201 and spin-coated at 4000 rpm for 20 seconds. In addition, the hollow silica application solution 1 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

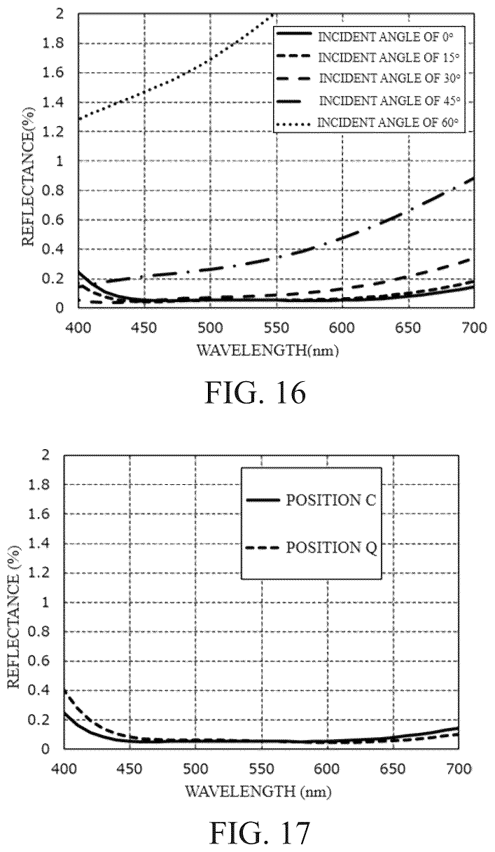

FIG. 16 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 17 illustrates the reflectance characteristic of the optical element 301 according to this example at the incident angle of 0° at positions C and Q. According to Table 7, the film thickness of each thin film layer at position Q is larger than that at position C by approximately 2%, but it can be confirmed that the reflectance is equal to or smaller than 0.2% for light in a wavelength band of 420 nm to 680 nm and is excellent.

TABLE 7

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 120.4 | 124.6 |
| FILM 101 | LAYER 13 | | | | |
| | THIN FILM | POLYIMIDE RESIN | 1.62 | 23.6 | 24.1 |
| | LAYER 12 | | | | |
| | THIN FILM | SOLID SILICA | 1.35 | 38.2 | 39.0 |
| | LAYER 11 | | | | |
| TRANSPARENT | | K22R | 1.54 | — | — |
| SUBSTRATE 201 | | | | | |

### Example 8

Example 8 will now be described. FIG. 2 is a schematic sectional view of an optical element 301 according to this example. The optical element 301 according to this example is an optical element in which an antireflection film 101 is formed on an transparent substrate 201. The transparent substrate 201 is EP-5000 (manufactured by Mitsubishi Gas Chemical Company, Inc.) having a refractive index of 1.64 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including solid silica as a primary component, the thin film layer 12 is made of a material including polyimide resin as a primary component, and the thin film layer 13 is made of a material including hollow silica as a primary component. Table 8 lists details of the film configuration of the optical element 301 according to this example. The refractive indices and film thicknesses of the materials satisfy inequalities (1) to (8) and (10) to (12). Each of the thin film layers 11, 12, and 13 includes an organic compound.

The antireflection film 101 according to this example is formed by the following method.

The antireflection film 101 is formed with the solid silica application solution 2, the polyimide application solution 2, and the hollow silica application solution 2.

The solid silica application solution 2 of 0.2 ml is dropped on the lens surface of the transparent substrate 202 and spin-coated at 4000 rpm for 20 seconds. Next, the polyimide application solution 2 of 0.2 ml is dropped on the lens surface of the transparent substrate 202 and spin-coated at 4000 rpm for 20 seconds. The hollow silica application solution 2 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

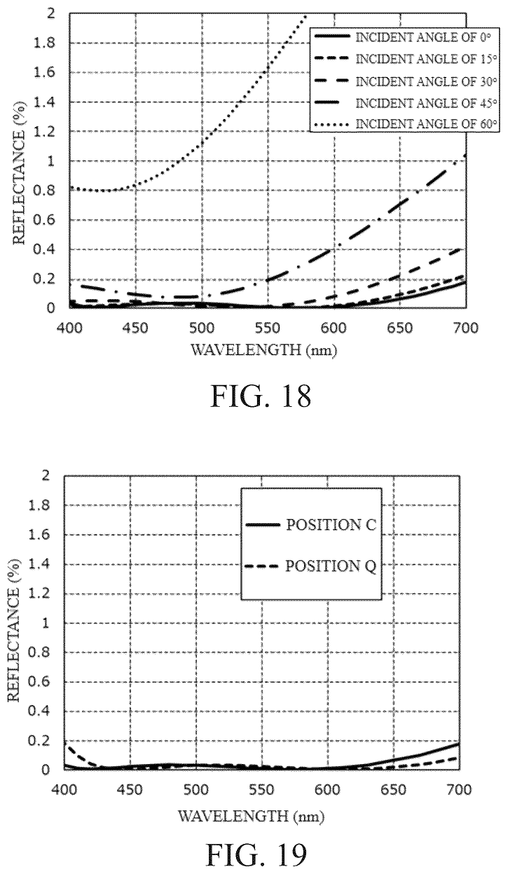

FIG. 18 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 19 illustrates the reflectance characteristic of the optical element 301 according to this example at the incident angle of 0° at positions C and Q. According to Table 8, the film thickness of each thin film layer at position Q is larger than that at position C by 6%, but it can be confirmed that the reflectance characteristic is equal to or smaller than 0.2% for light in a wavelength band of 420 nm to 680 nm and is excellent.

TABLE 8

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.14 | 118.7 | 126.4 |
| FILM 101 | LAYER 13 | | | | |
| | THIN FILM | POLYIMIDE RESIN | 1.68 | 19.3 | 20.4 |
| | LAYER 12 | | | | |
| | THIN FILM | SOLID SILICA | 1.35 | 44.7 | 47.2 |
| | LAYER 11 | | | | |
| TRANSPARENT | | EP-5000 | 1.64 | — | — |
| SUBSTRATE 201 | | | | | |

### Example 9

Example 9 will now be described. FIG. 3 is a schematic sectional view of an optical element 302 according to this example. The optical element 302 according to this example is an optical element in which an antireflection film 102 is formed on a transparent substrate 202. The transparent substrate 202 is EP-9000 (manufactured by Mitsubishi Gas Chemical Company, Inc.) having a refractive index of 1.64 (for light with a wavelength of 550 nm). The lens surface of the transparent substrate 202 on which the antireflection film 102 is formed has a convex surface shape. The half open angle ϕ at position Q on the maximum ray effective diameter is 30°. As for layer materials, the thin film layer 21 is made of a material including solid silica as a primary component, the thin film layer 22 is made of a material including polyimide resin as a primary component, and the thin film layer 23 is made of a material including hollow silica as a primary component. Table 9 lists details of the film configuration of the optical element 302 according to this example. The refractive indices and film thicknesses of the materials satisfy inequalities (1) to (8) and (10) to (12). Each of the thin film layers 21, 22, and 23 includes an organic compound.

The antireflection film 102 according to this example is formed by the following method.

The antireflection film 102 is formed with the solid silica application solution 1, the polyimide application solution 1, and the chain silica application solution 1. The solid silica application solution 1 of 0.2 ml is dropped on the lens surface of the transparent substrate 202 and spin-coated at 4000 rpm for 20 seconds. Next, the polyimide application solution 1 of 0.2 ml is dropped on the lens surface of the transparent substrate 202 and spin-coated at 4000 rpm for 20 seconds. The chain silica application solution 1 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

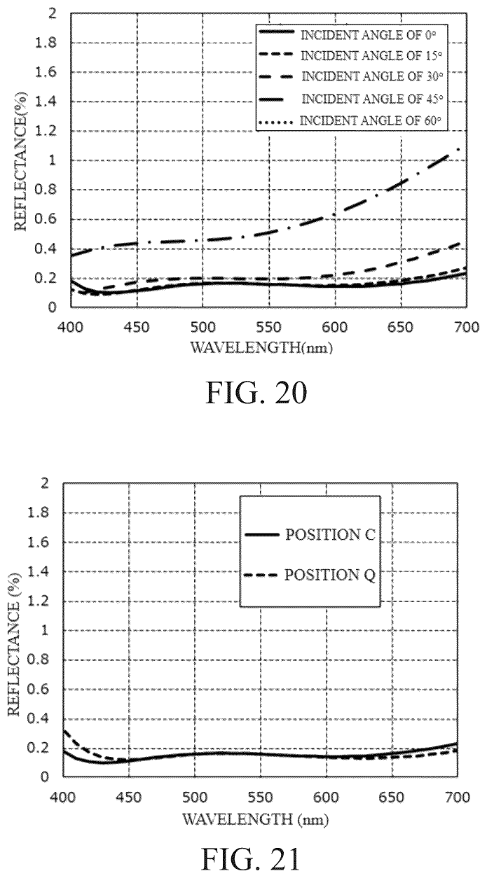

FIG. 20 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 21 illustrates the reflectance characteristic of the optical element 302 according to this example at the incident angle of 0° at positions C and Q. According to Table 9, the film thickness of each thin film layer at position Q is larger than that at position C by 2%, but it can be confirmed that the reflectance characteristic is equal to or smaller than 0.2% for light in a wavelength band of 420 nm to 680 nm and is excellent.

TABLE 9

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | CHAIN SILICA | 1.24 | 110.8 | 114.6 |
| FILM 102 | LAYER 23 | | | | |
| | THIN FILM | POLYIMIDE RESIN | 1.62 | 43.1 | 43.9 |
| | LAYER 22 | | | | |
| | THIN FILM | SOLID SILICA | 1.35 | 20.6 | 21.0 |
| | LAYER 21 | | | | |
| TRANSPARENT | | EP-9000 | 1.68 | — | — |
| SUBSTRATE 202 | | | | | |

### Example 10

Example 10 will now be described. FIG. 3 is a schematic sectional view of an optical element 302 according to this example. The optical element 302 according to this example is an optical element in which an antireflection film 102 is formed on a transparent substrate 202. The transparent substrate 202 is an optical element called a replica element in which the transparent substrate 202 is formed on the surface of a glass base material (not illustrated in diagrams) as a base material. The transparent substrate 202 is LPQ-1500 (Manufactured by Mitsubishi Gas Chemical Company, Inc.) having a refractive index of 1.59 (for light with a wavelength of 550 nm). The lens surface of the transparent substrate 202 on which the antireflection film 102 is formed has a convex surface shape. The half open angle ϕ at position Q on the maximum ray effective diameter is 30°. As for layer materials, the thin film layer 21 is made of a material including solid silica as a primary component, the thin film layer 22 is made of a material including polyimide resin as a primary component, and the thin film layer 23 is made of a material including hollow silica as a primary component. Table 10 lists details of the film configuration of the optical element 302 according to this example. The refractive indices and film thicknesses of the materials satisfy inequalities (1) to (8) and (10) to (12). Each of the thin film layers 21, 22, and 23 includes an organic compound.

The antireflection film 102 according to this example is formed by the following method.

The antireflection film 102 is formed with the solid silica application solution 1, the polyimide application solution 2, and the hollow silica application solution 1. The solid silica application solution 1 of 0.2 ml is dropped on the lens surface of the transparent substrate 202 and spin-coated at 4000 rpm for 20 seconds. Next, the polyimide application solution 2 of 0.2 ml is dropped on the lens surface of the transparent substrate 202 and spin-coated at 4000 rpm for 20 seconds. The hollow silica application solution 1 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

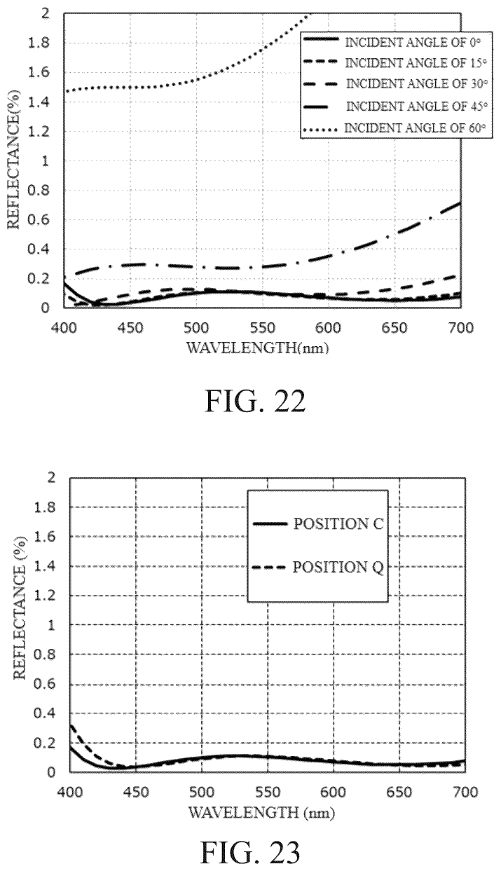

FIG. 22 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 23 illustrates the reflectance characteristic of the optical element 302 according to this example at the incident angle of 0° at positions C and Q. According to Table 10, the film thickness of each thin film layer at position Q is larger than that at position C by 2%, but it can be confirmed that the reflectance characteristic is equal to or smaller than 0.2% for light in a wavelength band of 420 nm to 680 nm and is excellent.

TABLE 10

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 123.4 | 127.6 |
| FILM 102 | LAYER 23 | | | | |
| | THIN FILM | POLYIMIDE RESIN | 1.68 | 22.2 | 22.6 |
| | LAYER 22 | | | | |
| | THIN FILM | SOLID SILICA | 1.35 | 41.6 | 42.5 |
| | LAYER 21 | | | | |
| TRANSPARENT | | LPQ-1500 | | — | — |
| SUBSTRATE 202 | | | | | |

### Example 11

Example 11 will now be described. FIG. 2 is a schematic sectional view of an optical element 301 according to this example. The optical element 301 according to this example is an optical element in which an antireflection film 101 is formed on a transparent substrate 201. The transparent substrate 201 is S-LAH66 (manufactured by OHARA INC.) having a refractive index of 1.77 (for light with a wavelength of 550 nm). The lens surface of the transparent substrate 201 on which the antireflection film 101 is formed has a concave surface shape. The half open angle ϕ at position Q on the maximum ray effective diameter is 30°. As for layer materials, the thin film layer 11 is made of a material including polyimide resin as a primary component, the thin film layer 12 is made of a material including solid silica as a primary component, and the thin film layer 13 is made of a material including hollow silica as a primary component. Table 11 lists details of the film configuration of the optical element according to this example. The refractive indices and film thicknesses of the materials satisfy inequalities (1) and (10) to (12). Each of the thin film layers 11, 12, and 13 includes an organic compound.

The antireflection film 101 according to this example is formed by the following method. The antireflection film 101 is formed with the polyimide application solution 1, the solid silica application solution 1, and the hollow silica application solution 1.

The polyimide application solution 1 of 0.2 ml is dropped on the lens surface of the transparent substrate 202 and spin-coated at 4000 rpm for 20 seconds. Next, the solid silica application solution 1 of 0.2 ml is dropped on the lens surface of the transparent substrate 202 and spin-coated at 4000 rpm for 20 seconds. The hollow silica application solution 1 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

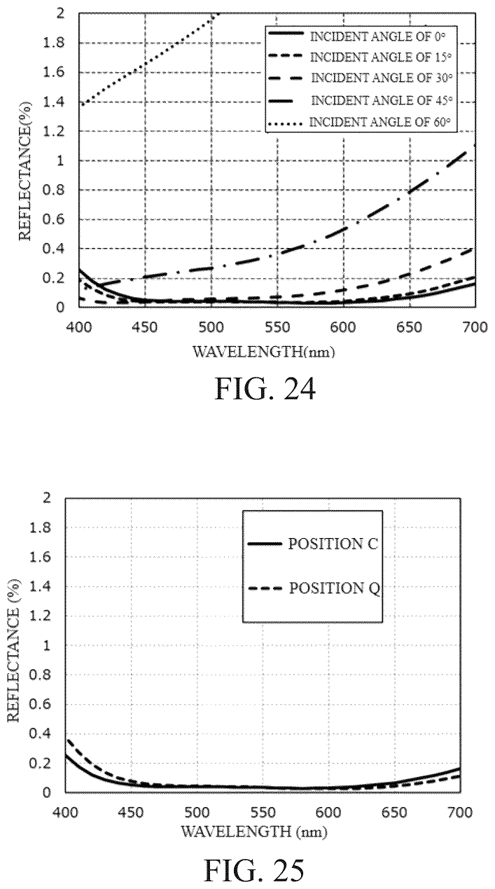

FIG. 24 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 25 illustrates the reflectance characteristic of the optical element 301 according to this example at the incident angle of 0° at positions C and Q. According to Table 11, the film thickness of each thin film layer at position Q is larger than that at position C by 6%, but it can be confirmed that the reflectance characteristic is equal to or smaller than 0.2% for light in a wavelength band of 420 nm to 680 nm and is excellent.

TABLE 11

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.19 | 79.8 | 82.6 |
| FILM 101 | LAYER 13 | | | | |
| | THIN FILM | SOLID SILICA | 1.35 | 47.1 | 48.0 |
| | LAYER 12 | | | | |
| | THIN FILM | POLYIMIDE RESIN | 1.62 | 70.1 | 71.5 |
| | LAYER 11 | | | | |
| TRANSPARENT | | S-LAH66 | 1.77 | — | — |
| SUBSTRATE 201 | | | | | |

### Example 12

Example 12 will now be described. FIG. 3 is a schematic sectional view of an optical element 302 according to this example. The optical element 302 according to this example is an optical element in which an antireflection film 102 is formed on a transparent substrate 202. The transparent substrate 202 is S-TIH53 (manufactured by OHARA INC.) having a refractive index of 1.85 (for light with a wavelength of 550 nm). The lens surface of the transparent substrate 202 on which the antireflection film 102 is formed has a concave surface shape. The half open angle ϕ at position Q on the maximum ray effective diameter is 30°. As for layer materials, the thin film layer 21 is made of a material including polyimide resin as a primary component, the thin film layer 22 is made of a material including solid silica as a primary component, and the thin film layer 23 is made of a material including hollow silica as a primary component. Table 12 lists details of the film configuration of the optical element 302 according to this example. The refractive indices and film thicknesses of the materials satisfy inequalities (1) and (10) to (12). Each of the thin film layers 21, 22, and 23 includes an organic compound.

The antireflection film 102 according to this example is formed by the following method.

The antireflection film 102 is formed with the polyimide application solution 2, the solid silica application solution 1, and the hollow silica application solution 2. The polyimide application solution 2 of 0.2 ml is dropped on the lens surface of the transparent substrate 202 and spin-coated at 4000 rpm for 20 seconds. Next, the solid silica application solution 1 of 0.2 ml is dropped on the lens surface of the transparent substrate 202 and spin-coated at 4000 rpm for 20 seconds. The hollow silica application solution 2 of 0.2 ml is continuously dropped on the lens surface of the transparent substrate 202 and spin-coated at 4000 rpm for 20 seconds. Thereafter, drying is performed in a clean room at room temperature of 23° C. for 24 hours or longer.

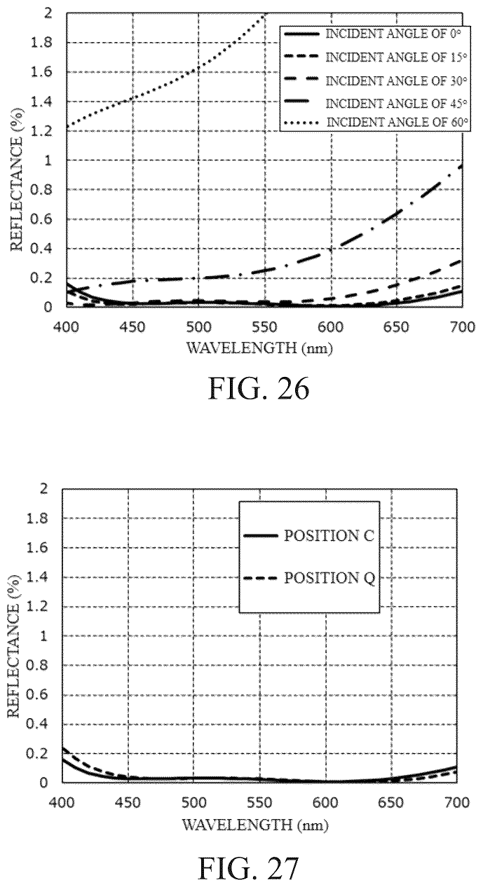

FIG. 26 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 27 illustrates the reflectance characteristic of the optical element 302 according to this example at the incident angle of 0° at positions C and Q. According to Table 12, the film thickness of each thin film layer at position Q is larger than that at position C by 2%, but it can be confirmed that the reflectance characteristic is equal to or smaller than 0.2% for light in a wavelength band of 420 nm to 680 nm and is excellent.

TABLE 12

| | | | | PHYSICAL FILM | |
|---|---|---|---|---|---|
| | | | | THICKNESS(nm) | |
| | | | | POSITION | POSITION |
| | | | REFLECTANCE | C | Q |
| ANTIREFLECTION | THIN FILM | HOLLOW SILICA | 1.14 | 79.4 | 82.1 |
| FILM 102 | LAYER 23 | | | | |
| | THIN FILM | SOLID SILICA | 1.35 | 69.4 | 70.8 |
| | LAYER 22 | | | | |
| | THIN FILM | POLYIMIDE RESIN | 1.68 | 69.2 | 70.6 |
| | LAYER 21 | | | | |
| TRANSPARENT | | S-TIH53 | 1.85 | — | — |
| SUBSTRATE 202 | | | | | |

### Example 13

Example 13 will now be described. FIG. 2 is a schematic sectional view of an optical element 301 according to this example. The optical element 301 according to this example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including magnesium fluoride as a primary component, the thin film layer 12 is made of a material including alumina as a primary component, and the thin film layer 13 is made of a material including hollow silica as a primary component. Table 13 lists details of the film configuration of the optical element 301 according to this example. The refractive indices and film thicknesses of the materials satisfy inequalities (1) to (8) and (10) to (12).

The antireflection film 101 according to this example is formed by the following method.

The thin film layers 11 and 12 are formed by an evaporation method. An electron beam is used to heat an evaporation material. In addition, an ion beam assist evaporation method is performed to form a denser film. A vacuum chamber of an evaporation apparatus is evacuated to a high vacuum region near 2×10-3 (Pa) in a non-heating state. After the high vacuum state inside the vacuum chamber is confirmed, Ar as inert gas is introduced into an ion gun, and then the ion gun is electrically discharged. After the ion gun becomes stable, oxygen is introduced into the vacuum chamber and ion assist evaporation with oxygen ions is performed at the vacuum pressure of approximately 1×10-2 (Pa). Typically, the evaporation method has a problem in that the film thickness of a lens having a large half open angle decreases as a position moves to a peripheral part. During evaporation, Example 13 provides a mask with an arbitrary shape on the film forming surface side of the transparent substrate 201 to avoid film thickness decrease at the peripheral part and to make substantially uniform the film thickness distribution within the surface.

Following the thin film layer 11, the thin film layer 12 is formed by evaporation, and then the hollow silica application solution 1 of 0.2 ml is dropped on the lens surface of the transparent substrate 202 on which the thin film layers 11 and 12 are formed, and is spin-coated at 4000 rpm for 20 seconds. Thereafter, drying is performed in a clean room at room temperature of 23° C. for 24 hours or longer.

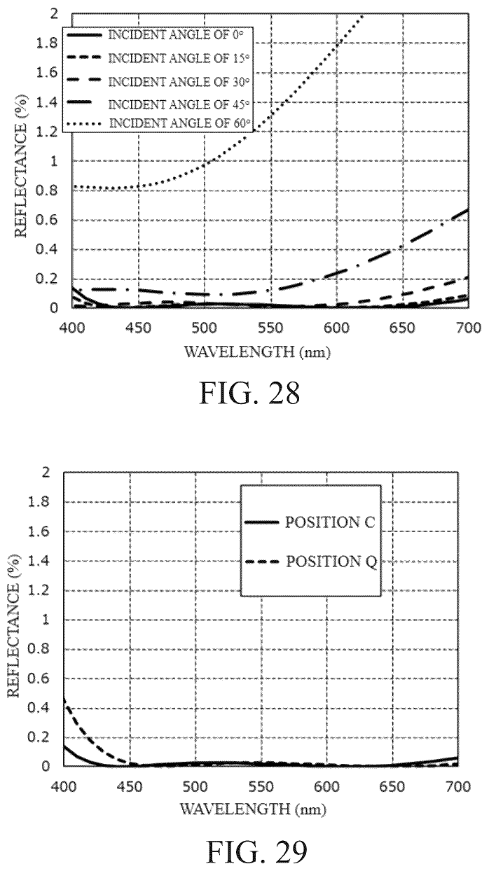

FIG. 28 illustrates the reflectance characteristic of the optical element 301 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 29 illustrates the reflectance characteristic of the optical element 301 according to this example at the incident angle of 0° at positions C and Q. According to Table 13, the film thickness of each thin film layer at position Q is larger than that at position C by 6%, but it can be confirmed that the reflectance characteristic is equal to or smaller than 0.2% for light in a wavelength band of 420 nm to 680 nm and is excellent.

TABLE 13

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION- | TION |
| | | | TANCE | C | Q |
| ANTIRE- | THIN FILM | HOLLOW | 1.14 | 123.3 | 131.4 |
| FLECTION | LAYER 13 | SILICA | | | |
| FILM 101 | THIN FILM | Al₂O₃ | 1.64 | 10.6 | 11.2 |
| | LAYER 12 | | | | |
| | THIN FILM | MgF₂ | 1.39 | 69.8 | 73.7 |
| | LAYER 11 | | | | |
| TRANS- | | S-TIL26 | 1.57 | — | — |
| PARENT | | | | | |
| SUBSTRATE | | | | | |
| 201 | | | | | |

### Example 14

Example 14 will now be described. FIG. 3 is a schematic sectional view of an optical element 302 according to this example. The optical element 302 according to this example is an optical element in which an antireflection film 102 is formed on a transparent substrate 202. The transparent substrate 202 is S-LAH79 (manufactured by OHARA INC.) having a refractive index of 2.00 (for light with a wavelength of 550 nm). The lens surface of the transparent substrate 202 on which the antireflection film 102 is formed has a concave surface shape. The half open angle ϕ at position Q on the maximum ray effective diameter is 30°. As for layer materials, the thin film layer 21 is made of a material including magnesium fluoride as a primary component, the thin film layer 22 is made of a material including zirconia oxide and alumina as primary components, and the thin film layer 23 is made of a material including hollow silica as a primary component. Table 14 lists details of the film configuration of the optical element 302 according to this example. The refractive indices and film thicknesses of the materials satisfy inequalities (1) to (8) and (10) to (12).

The antireflection film 102 according to this example is formed by the following method. The thin film layers 21 and 22 are formed by an evaporation method. The evaporation method is similar to that of Example 13. This example also uses a mask such that film thickness distribution is substantially uniform within the surface. Following the thin film layer 21, the thin film layer 22 is formed by evaporation, and then the hollow silica application solution 1 of 0.2 ml is dropped on the lens surface of the transparent substrate 202 on which the thin film layers 21 and 22 are formed, and is spin-coated at 4000 rpm for 20 seconds. Thereafter, drying is performed in a clean room at room temperature of 23° C. for 24 hours or longer.

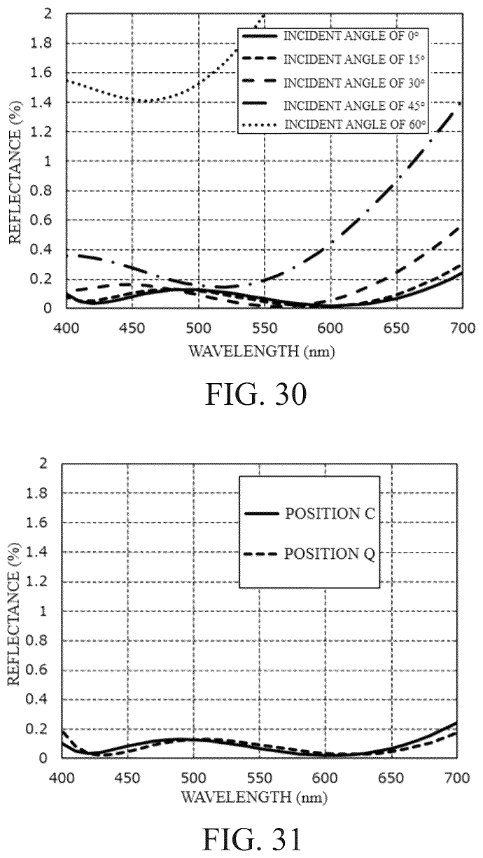

FIG. 30 illustrates the reflectance characteristic of the optical element 302 according to this example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 31 illustrates the reflectance characteristic of the optical element 302 according to this example at the incident angle of 0° at positions C and Q. According to Table 13, the film thickness of each thin film layer at position Q is larger than that at position C by 2%, but it can be confirmed that the reflectance characteristic is equal to or smaller than 0.2% for light in a wavelength band of 420 nm to 680 nm and is excellent.

TABLE 14

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION- | TION |
| | | | TANCE | C | Q |
| ANTIRE- | THIN FILM | HOLLOW | 1.19 | 107.8 | 111.5 |
| FLECTION | LAYER 23 | SILICA | | | |
| FILM 102 | THIN FILM | ZrO₂ + | 1.68 | 47.6 | 48.6 |
| | LAYER 22 | Al₂O₃ | | | |
| | THIN FILM | MgF₂ | 1.39 | 17.8 | 18.2 |
| | LAYER 21 | | | | |
| TRANS- | | S-LAH79 | 2.00 | — | — |
| PARENT | | | | | |
| SUBSTRATE | | | | | |
| 202 | | | | | |

### Example 15

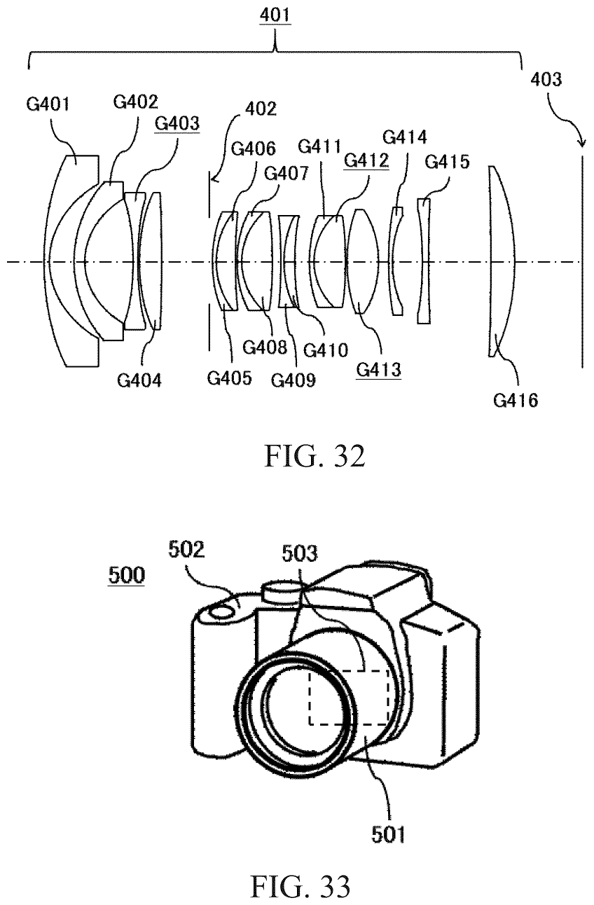

Referring now to FIG. 32, a description will be given of an optical system 401 according to Example 15. FIG. 32 is a sectional view of the optical system 401. The optical system 401 includes a plurality of optical elements G401 to G416. Reference numeral 402 denotes an aperture stop (diaphragm), and reference numeral 403 denotes an imaging surface. Each of the optical elements G401 to G411 is a lens. The antireflection film according to any one of Examples 1 to 14 is provided on at least one of the entrance surface and emission surface of each lens. That is, the optical system 401 includes the plurality of optical elements G401 to G411, and the plurality of optical elements G403, G412, and G143 include the optical element 301 or 302 on which the antireflection film according to any one of Examples 1 to 14 is formed.

The optical system 401 according to this example is not limited to an image pickup optical system included in an image pickup apparatus to be described below but is also applicable to optical systems of various applications, such as a binocular, a projector, and a telescope.

### Example 16

Referring now to FIG. 33, a description will be given of an image pickup apparatus according to Example 16. FIG. 33 is an external perspective view of the image pickup apparatus (digital camera 500). The digital camera 500 includes a camera body 502, and a lens apparatus 501 integrated with the camera body 502. However, this example is not limited to this implementation, and the lens apparatus 501 may be an interchangeable lens attached to and detachable from the camera body 502, such as an interchangeable lens for a single-lens reflex camera, a mirrorless camera, or the like. The lens apparatus 501 includes an optical system 401 according to any one of Examples 1 to 15. The camera body 502 includes an image sensor 503 such as a CMOS sensor or a CCD sensor. The image sensor 503 is disposed on an imaging surface 403 of the optical system 401.

### Comparative Example 1

Next, comparative example 1 will now be described. FIG. 2 is a schematic sectional view of an optical element 301 according to this comparative example. The optical element 301 according to this comparative example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including magnesium fluoride as a primary component, the thin film layer 12 is made of a material including alumina as a primary component, and the thin film layer 13 is made of a material including hollow silica as a primary component. Table 15 lists details of the film configuration of the optical element according to this comparative example. The refractive indices and film thicknesses of the materials satisfy inequalities (1) to (8) but do not satisfy inequalities (10) and (11).

The antireflection film 101 according to this comparative example is formed by the following method. The thin film layers 11 and 12 are formed by an evaporation method. The evaporation method is similar to that of Example 13. This comparative example uses no mask for making the film thickness distribution substantially uniform within the surface. Following the thin film layer 11, the thin film layer 12 is formed by evaporation, and then the hollow silica application solution 1 of 0.2 ml is dropped on the lens surface of the transparent substrate 201 on which the thin film layers 11 and 12 are formed, and is spin-coated at 4000 rpm for 20 seconds. Thereafter, drying is performed in a clean room at room temperature of 23° C. for 24 hours or longer.

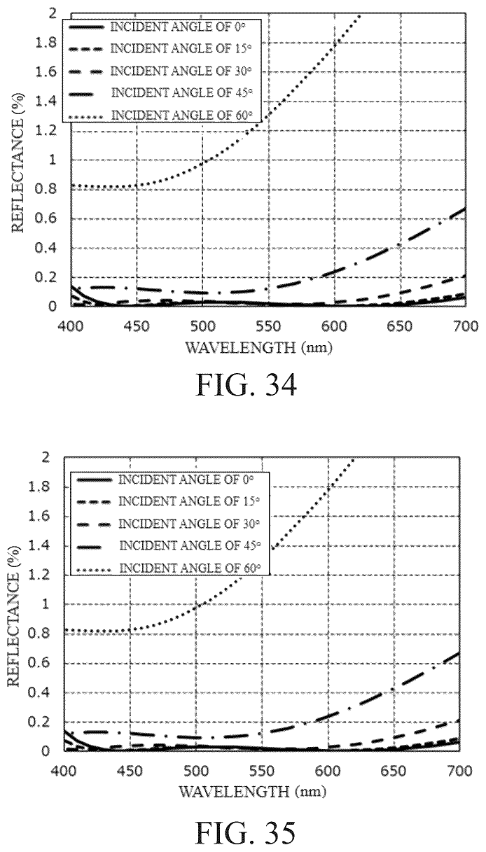

FIG. 34 illustrates the reflectance characteristic of the optical element 301 according to this comparative example at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. However, when the reflectance characteristic at the incident angle of 0° is compared between positions C and Q in FIG. 35, the reflectance characteristic at position Q is lower than that at position C. According to Table 14, the film thickness of the thin film layer 12 at position Q is larger than that at position C by 6%, but the film thicknesses of the thin film layers 11 and 12 at position Q are smaller than those at position C by 30%. Thus, the reflectance characteristic at position Q deteriorates.

TABLE 15

| | | | | PHYSICAL | |
|---|---|---|---|---|---|
| | | | | FILM | |
| | | | | THICKNESS | |
| | | | | (mm) | |
| | | | | POSI- | POSI- |
| | | | | TION | TION |
| | | | | C | Q |
| ANTIRE- | THIN FILM | HOLLOW | 1.14 | 123.3 | 130.3 |
| FLECTION | LAYER 13 | SILICA | | | |
| FILM 101 | THIN FILM | Al₂O₃ | 1.64 | 10.6 | 7.5 |
| | LAYER 12 | | | | |
| | THIN FILM | MgF₂ | 1.39 | 69.8 | 49.4 |
| | LAYER 11 | | | | |
| TRANS- | | S-TIL26 | 1.57 | — | — |
| PARENT | | | | | |
| SUBSTRATE | | | | | |
| 201 | | | | | |

### Comparative Example 2

Next, comparative example 2 will now be described. FIG. 2 is a schematic sectional view of an optical element 301 according to this comparative example. The optical element 301 according to this comparative example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including solid silica as a primary component, the thin film layer 12 is made of a material including polyimide resin as a primary component, and the thin film layer 13 is made of a material including hollow silica as a primary component.

Table 16 lists details of the film configuration of the optical element 301 according to this comparative example. The refractive index of the thin film layer 13 does not satisfy inequalities (1) and (4).

The antireflection film 101 according to this comparative example is formed by the following method.

### Chain Silica Application Solution 2

Chain particle dispersion solution 2 and binder solution 2 are produced by a method similar to that of the hollow particle application solution 1. The chain particle binder solution 2 of 78.0 g is added to the dispersion solution 2 of 251.3 g. Thereafter, 1-propoxy-2-propanol of 174.5 g and lactic acid ethyl of 510.8 g are added and agitated for 60 minutes, and chain silica application solution 2 is obtained.

The antireflection film 101 is formed with the solid silica application solution 1, the polyimide application solution 1, and the chain silica application solution 2.

The solid silica application solution of 0.2 ml is dropped on the lens surface of the transparent substrate 201 and spin-coated at 4000 rpm for 20 seconds. Next, the polyimide application solution 1 of 0.2 ml is dropped on the lens surface of the transparent substrate 201 and spin-coated at 4000 rpm for 20 seconds. In addition, the chain silica application solution 2 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

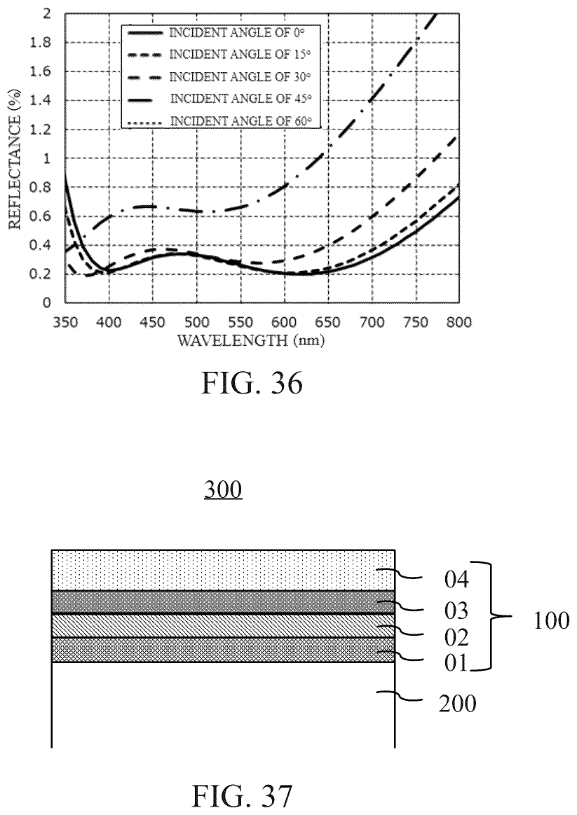

FIG. 36 illustrates the reflectance characteristic of the optical element 301 according to this comparative example at the incident angles of 0°, 15°, 30°, 45°, and 60° at position C. The reflectance is equal to or larger than 0.2% for light in a wavelength band of 420 nm to 680 nm at an incident angle of 0°, and thus sufficient antireflection performance is not obtained.

TABLE 16

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | CHAIN | 1.30 | 107.9 | — |
| FLECTION | LAYER 13 | SILICA | | | |
| FILM 101 | THIN FILM | POLYIMIDE | 1.62 | 41.0 | — |
| | LAYER 12 | RESIN | | | |
| | THIN FILM | SOLID | 1.35 | 11.5 | — |
| | LAYER 11 | SILICA | | | |
| TRANS- | | S-TIL26 | 1.57 | — | — |
| PARENT | | | | | |
| SUBSTRATE | | | | | |
| 201 | | | | | |

Each example can provide an optical element, an optical system, an image pickup apparatus, and a manufacturing method of an optical element, each of which can sufficiently lower reflectance irrespective of the refractive index of a substrate (base material).

Referring now to FIG. 37, a schematic description will be given of the optical element 300 according to any one of Examples 17 to 25. FIG. 37 is a schematic diagram of the optical element 300. The optical element 300 includes a transparent substrate (base material) 200 and an antireflection film 100 consisting of four layered films. The antireflection film 100 consists of a thin film layer (first layer) 01, a thin film layer (second layer) 02, a thin film layer (third layer) 03, and a thin film layer (fourth layer) 04 in order from the transparent substrate 200 toward an air side.

For light with a wavelength of 550 mn, n1 is a refractive index of the thin film layer 01, n2 is a refractive index of the thin film layer 02, n3 is a refractive index of the thin film layer 03, and n4 is a refractive index of the thin film layer 04. d1 (nm) is a physical thickness of the thin film layer 01, d2 (nm) is a physical thickness of the thin film layer 02, d3 (nm) is a physical thickness of the thin film layer 03, and d4 (nm) is a physical thickness of the thin film layer 04. In this case, at least one of the following inequalities (15) to (22) may be satisfied:

$$1.56 \leq n 1 \leq 1.7 \qquad ( 15 )$$

$$1.3 \leq n 2 \leq 1.5 \qquad ( 16 )$$

$$1.56 \leq n 3 \leq 1.7 \qquad ( 17 )$$

$$1.1 \leq n 4 \leq 1.28 \qquad ( 18 )$$

$$40 \leq n 1 d 1 \leq 250 \qquad ( 19 )$$

$$10 \leq n 2 d 2 \leq 100 \qquad ( 20 )$$

$$10 \leq n 3 d 3 \leq 100 \qquad ( 21 )$$

$$100 \leq n 4 d 4 \leq 155 \qquad ( 22 )$$

$$200 \leq n 1 d 1 + n 2 d 2 + n 3 d 3 + n 4 d 4 \leq 550 \qquad ( 23 )$$

Sufficient antireflection performance cannot be obtained in a case where the refractive index or physical thickness of any material is outside the ranges of inequalities (15) to (23).

Inequality (18) may be replaced with the following inequality (24):

$$1.12 \leq n 4 \leq 1.22 \qquad ( 24 )$$

Inequality (18) may be replaced with the following inequality (24a):

$$1.15 \leq n 4 \leq 1.22 \qquad ( 24 a )$$

The thin film layers 02, 03, and 04 of the optical element 300 according to each example may consist of a material including an organic compound. The “organic compound” in this embodiment is a compound including carbon except for compounds having a simple structure, such as carbon monoxide and carbon dioxide. The material including the “organic compound” can be easily formed by a wet coating method.

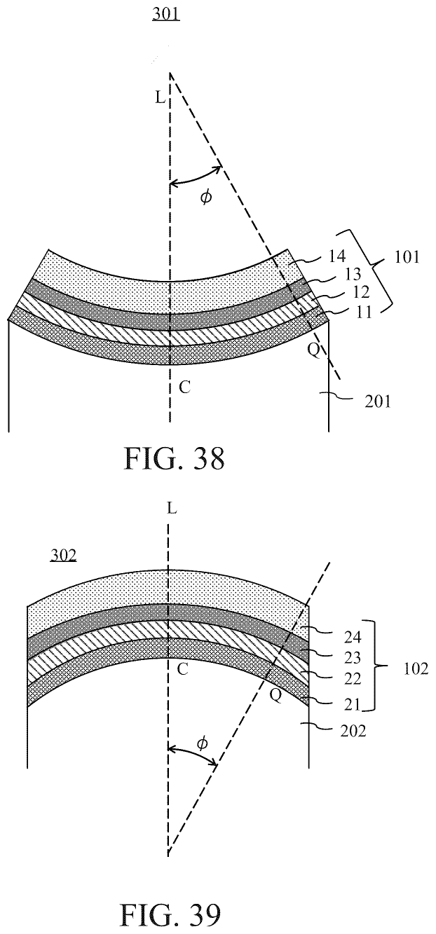

The optical element 301 or 302 according to an embodiment of the present disclosure illustrated in FIG. 38 or 39 is a schematic diagram in a case where the surface of the transparent substrate 201 or 202 on which the antireflection film 101 or 102 is formed has a concave or convex surface shape. The following description will discuss only the concave surface shape illustrated in FIG. 38 but is similarly applicable to the convex surface shape illustrated in FIG. 39.

An optical surface of the optical element 301 for forming the antireflection film 101 has a shape with a rotational symmetry axis (e.g., reference axis; for example, a surface normal passing through an origin (e.g., surface vertex)), in other words, a rotationally symmetric shape. However, each example is not limited to this implementation, and the optical surface at which the antireflection film 101 is formed may have no rotational symmetry. In FIG. 38, position C is the rotational center of a lens surface of the transparent substrate 201 on which the antireflection film 101 is provided. In other words, position C is a position (intersection) where the rotational symmetry axis (optical axis L) of the lens surface intersects the lens surface of the transparent substrate 201. On the other hand, position Q is located at a location farthest from position C in an optical effective area on the lens surface of the transparent substrate 201. The optical effective area is an area (e.g., effective diameter) on the optical surface, through which an effective light beam that contributes to imaging passes.

Where ϕ is an angle (referred to as a half open angle hereinafter) between the optical axis L and the normal at position Q, the half open angle ϕ has a maximum value in the optical effective area. The antireflection film 101 consists of a thin film layer (first layer) 11, a thin film layer (second layer) 12, a thin film layer (third layer) 13, and a thin film layer (fourth layer) 14 in order from the transparent substrate 201. At position C, d2c (nm) is a physical thickness of the thin film layer 12, d3c is a physical thickness of the thin film layer 13, and d4c (nm) is a physical thickness of the thin film layer 14. At position Q, d2q (nm) is a physical thickness of the thin film layer 12, d3q (nm) is a physical thickness of the thin film layer 13, and d4q (nm) is a physical thickness of the thin film layer 14. In this case, at least one of the following inequalities (25) to (27) may be satisfied:

$$1. < d 2 q / d 2 c \leq 13 \qquad ( 25 )$$

$$1. < d 3 q / d 3 c \leq 1.3 \qquad ( 26 )$$

$$1. < d 4 q / d 4 c \leq 1.3 \qquad ( 27 )$$

In each example, each of the film thicknesses of the thin film layers 12, 13, and 14 constituting the antireflection film 101 may be smallest at position C as the center (the optical axis center) of the antireflection film 101 and larger as a position is farther from the optical axis center.

In each example, the half open angle ϕ (°) at position Q may satisfy the following inequality (28):

$$25 \leq ϕ < 90 \qquad ( 28 )$$

The following inequality (29) may be satisfied:

$$1.45 \leq nS \leq 2.10 \qquad ( 29 )$$

where nS is a refractive index of the transparent substrate 201.

The thin film layer 11 of the antireflection film 101 and the thin film layer 21 of the antireflection film 102 in FIGS. 38 and 39 may be made of a material including an organic compound similarly to the thin film layers 12, 13, and 14 and the thin film layers 22, 23, and 24. Similarly, the film forming method may be a wet film forming method, in particular, a spin coat method.

The following description will discuss only the concave surface shape illustrated in FIG. 38 but is similarly applicable to the convex surface shape illustrated in FIG. 39.

As for the thin film layer 11, the following inequality (30) may be satisfied:

$$1. < d 1 q / d 1 c \leq 1.3 \qquad ( 30 )$$

where d1c (nm) is a physical thickness of the thin film layer 11 at position C and d1q (nm) is a physical thickness of the thin film layer 11 at position Q.

The thin film layers 11 and 13 may satisfy the following inequality (31):

$$0.9 \leq d 1 / d 3 \leq 1.1 \qquad ( 31 )$$

The thin film layer 11 may be made of a material including polyimide resin, which is a “polymer compound containing an imide (—CO—NR—CO—) bond”. The imide bond has a plane structure, and a thin film layer having such a structure, molecule chains tend to orient parallel to a substrate during formation. Therefore, adhesion in the longitudinal direction is weaker than in the lateral direction, and the thin film layer can be easily peeled off by rubbing with cloth on which an appropriate amount of a polishing agent containing alumina-based minerals is applied. In the embodiment of the present disclosure, the thin film layers 12, 13, and 14 above the thin film layer 11, in other words, the entire antireflection film 101 can be peeled off from the transparent substrate 201, and a regeneration process in the manufacturing process becomes easy.

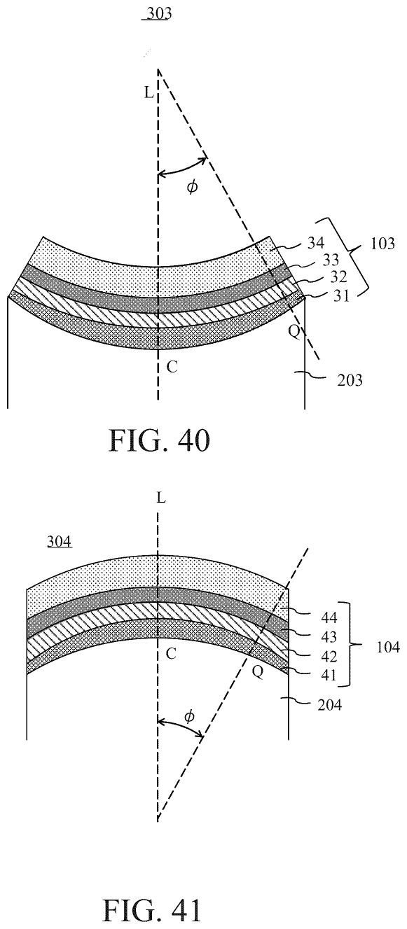

FIG. 40 or 41 illustrates an optical element 303 or 304 according to an embodiment of the present disclosure. The optical element 303 or 304 is a schematic diagram in a case where a surface of a transparent substrate 203 or 204, on which an antireflection film 103 or 104 is formed has a concave or convex surface shape. The following description will discuss only the concave surface shape illustrated in FIG. 40 but is similarly applicable to the convex surface shape illustrated in FIG. 41.

The antireflection film 103 consists of a thin film layer 31, a thin film layer 32, a thin film layer 33, and a thin film layer 34 in order from the transparent substrate 203. Similarly to the thin film layers 12, 13, and 14 of the antireflection film 101 described above, the thin film layers 32, 33, and 34 may consist of a material including an organic compound and satisfy inequalities (25) to (27).

The thin film layer 31 may include a material including aluminum oxide. Aluminum oxide exhibits excellent vapor shielding performance and can prevent substrate surface yellowing. In this case, the following inequality (19a) may be satisfied:

$$120 \leq n 1 d 1 \leq 250 \qquad ( 19 a )$$

In forming the thin film layer 31 by a dry film forming method such as vapor deposition or sputtering, an incident angle of an evaporation material on a lens surface is large at a peripheral part of a large open angle lens, and film thickness at the peripheral part is smaller than that at a central part. Thus, in FIG. 40, the physical thickness d31c (nm) of the thin film layer 31 at position C and the physical thickness d31q (nm) of the thin film layer 31 at position Q may satisfy the following inequality (32):

$$0.5 \leq d 31 q / d 31 c < 1. \qquad ( 32 )$$

The following inequality (33) may be satisfied:

$$- 0 \text{.1} \leq ns - nl \leq 0.1 \qquad ( 33 )$$

where ns is a refractive index of the transparent substrate 203 for light with a wavelength of 550 nm.

Interface reflection is small in a case where the refractive index difference between the transparent substrate 203 and the thin film layer 31 is small. Any unevenness of the film thickness of the thin film layer 31 within the lens surface is less likely to cause biasing of reflectance performance.

The following inequality (34) may be satisfied:

$$450 \leq Tg \leq 550 \qquad ( 34 )$$

where Tg (° C.) is the glass transition temperature of the transparent substrate 203.

A glass material having a low glass transition temperature is likely to have a problem such as yellowing, which arises from the glass material. Using aluminum oxide as a layer directly provided on the glass material can prevent reflectance decrease due to yellowing or the like.

The thin film layers 04, 14, 24, 34, and 44 may include a void. Since the void, in other words, air having a refractive index of 1.0 is included, the refractive indices can be decreased to inequalities (18) and (24). In a case where the refractive index is smaller than 1.10, the ratio of the voids included in the layer is high, and thus the film strength is low. In a case where the refractive index is larger than 1.28, sufficient antireflection performance is not obtained. An antifouling layer or the like may be provided as necessary on the surface of the antireflection film (e.g., surfaces of the thin film layers 04, 14, 24, 34, and 44) in each example. Examples of the antifouling layer include a fluorine polymer layer, a fluorosilane monomolecular layer, and a titanium oxide particle layer.

In each example, the thin film layers 04, 14, 24, 34, and 44 may be made of solid particles, chain particles, or hollow particles. The thin film layers may be made of hollow particles having a void inside. The void may be a single hole or multiple holes, which can be selected as appropriate. The material of solid particles, chain particles, or hollow particles may have a low refractive index. The material is, for example, organic resin made of SiO2, MgF2, fluorine, or silicon, but SiO2, particles of which can be easily manufactured may be used. The average particle diameter of the hollow particle may be equal to or larger than 15 nm and equal to or smaller than 100 nm, or may be equal to or larger than 15 nm and equal to or smaller than 80 nm. In a case where the average particle diameter of the hollow particle is smaller than 15 nm, it is difficult to reliably produce a particle as a core. In a case where the average particle diameter of the hollow particle exceeds 100 nm, the size of a void between particles becomes large, and thus a large void is likely to occur and scattering along with the particle size may occur.

The thin film layers 02, 12, 22, 32, and 42 may be made of a material including solid particles bonded with a binder such as siloxane bond, in particular, solid silica particles. Alternatively, the material may include acrylic resin as “acrylic acid ester or methacrylic acid ester polymer”.

The thin film layers 03, 13, 23, 33, and 43 may be made of a material including polyimide resin, which is a “polymer compound containing an imide (—CO—NR—CO—) bond”. Alternatively, the thin film layers may be made of a material including epoxy resin that is “resin crosslinked and cured with an epoxy group having oxacyclopropane (oxirane) as three-membered cyclic ether in a structural formula”.

In each example, the thin film layers 11, 21, the thin film layers 12, 22, 32, and 42, the thin film layers 13, 23, 33, and 43, and the thin film layers 14, 24, 34, and 44 may be formed by a wet film forming method that involves applying application solution containing a film material, followed by drying and calcining. The wet film forming method can inexpensively perform application of a large area. In particular, a spin coat method may be used because this method can flatten in-plane film thickness distribution by performing application while performing rotation about the rotational axis of an application surface.

An organic solvent that can be used for the application solution is not particularly limited as long as application easiness, performance, and the like are not degraded, but may be any well-known solvent. For example, the organic solvent may include monohydric alcohols such as methanol, ethanol, 1-propanol, 2-propanol, 1-butanol, 2-butanol, 2-methylpropanol, 1-pentanol, 2-pentanol, and cyclopentanol. The organic solvent may include 2-methylbutanol, 3-methylbutanol, 1-hexanol, 2-hexanol, 3-hexanol, 4-methyl-2-pentanol, 2-methyl-1-pentanol, and 2-ethylbutanol. The organic solvent may include 2,4-dimethyl-3-pentanol, 3-ethylbutanol, 1-heptanol, 2-heptanol, 1-octanol, and 2-octanol.

The organic solvent may include polyhydric alcohols such as ethylene glycol and triethylene glycol. The organic solvent may include ether alcohols, such as methoxyethanol, ethoxylethanol, propoxyethanol, iso-propoxyethanol, butoxyethanol, 1-methoxy-2-propanol, 1-ethoxyl-2-propanol, and 1-propoxy-2-propanol. The organic solvent may include ethers such as dimethoxyethane, diglyme, tetrahydrofuran, dioxane, diisopropyl ether, dibutyl ether, and cyclopentyl methyl ether.

The organic solvent may include esters such as formic acid ethyl, ethyl acetate, acetic acid n-butyl, lactic acid methyl, lactic acid ethyl, ethylene glycol monomethyl ether acetate, and ethylene glycol monoethyl ether acetate. The esters may be ethylene glycol monobutyl ether acetate and propylene glycol monomethyl ether acetate. The organic solvent may include various aliphatic or cycloaliphatic hydrocarbons such as n-hexane, n-octane, cyclohexane, cyclopentane, and cyclooctane. The organic solvent may include various aromatic hydrocarbons such as toluene, xylene, and ethyl benzene.

The organic solvent may include various ketones such as acetone, methyl ethyl ketone, methyl iso butyl ketone, cyclopentanone, and cyclohexanone. The organic solvent may include various chlorinated hydrocarbons such as chloroform, methylene chloride, carbon tetrachloride, and tetra chloroauric ethane. The organic solvent may include non-protonic polar solvents such as N-methyl pyrrolidone, N,N-dimethylformamide, N,N-dimethylacetamide, and ethylene carbonate. Among these solvents, two or more kinds of solvents may be used in mixture.

In a case where solid particles, chain particles, or hollow particles are used for the fourth thin film layers 04, 14, 24, 34, and 44 and solid particles are used for the second thin film layers 02, 12, 22, 32, and 42, a binder for binding may be used to improve the strength. The binder may be a siloxane bond, particularly in a case where silica particles with abundant hydroxyl groups are used on the surface.

In each example, the thin film layers 11 and 21, the thin film layers 12 and 22, the thin film layers 13 and 23, and the thin film layers 14 and 24 are made of a material that can be formed by the wet film forming method, and thus the material or the binder includes an organic compound. Moreover, the antireflection film according to each example is not calcined at a high temperature in the process of drying after application. Thus, for example, plastic and optical curable resin, which are prone to thermal deformation, can be used for the transparent substrates 201 and 202, all layers of which can be formed by the wet film forming method.

The thin film layers 31 and 41 may be formed by a dry film forming method such as an evaporation method or a sputter method. The dry film forming method such as an evaporation method or a sputter method forms a film in a positional relationship in which an evaporation source and a central part of a lens face each other. In a large open angle lens, an incident angle of an evaporation material on a lens surface is large at a peripheral part, and thus a film thickness at the peripheral part is smaller than that at a central part. Thus, film (thickness) unevenness occurs in the lens surface, and the antireflection performance is biased. However, in a case where inequality (19) is satisfied, interface reflection between the transparent substrate 200 and the thin film layers 31 and 41 decreases. Therefore, biasing of the reflectance performance reduces even when the film thicknesses of the thin film layers 31 and 41 have in-plane variance.

Specific examples will be described below. However, these examples are merely illustrative and this disclosure is not limited to the range of each example.

### Example 17

FIG. 38 is a schematic sectional view of an optical element 301 according to Example 17. The optical element 301 according to this example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including polyimide resin as a primary component, the thin film layer 12 is made of a material including solid silica as a primary component, the thin film layer 13 is made of a material including polyimide resin as a primary component, and the thin film layer 14 is made of a material including hollow silica as a primary component. Table 1 lists details of the film configuration of the optical element according to this example. The refractive indices and film thicknesses of the materials satisfy inequalities (15) to (23), (25) to (37), and (30). Each of the thin film layers 11, 12, 13, and 14 includes an organic compound.

The antireflection film 101 according to this example is formed by the following method.

The antireflection film 101 is formed with the solid silica application solution 1, the polyimide application solution 1, and the hollow silica application solution.

The polyimide application solution 1 of 0.2 ml is dropped on the lens surface of the transparent substrate 201 and spin-coated at 2000 rpm for 20 seconds. Next, the solid silica application solution 1 of 0.2 ml is continuously dropped on the lens surface of the transparent substrate 201 and spin-coated at 4000 rpm for 20 seconds. In addition, the polyimide application solution 1 of 0.2 ml is continuously dropped on the lens surface of the transparent substrate 201 and spin-coated at 4000 rpm for 20 seconds. Finally, the hollow silica application solution 1 of 0.2 ml is dropped on the lens surface of the transparent substrate 201 and spin-coated at 4000 rpm for 20 seconds. Thereafter, drying is performed in a clean room at room temperature of 23° C. for 24 hours or longer.

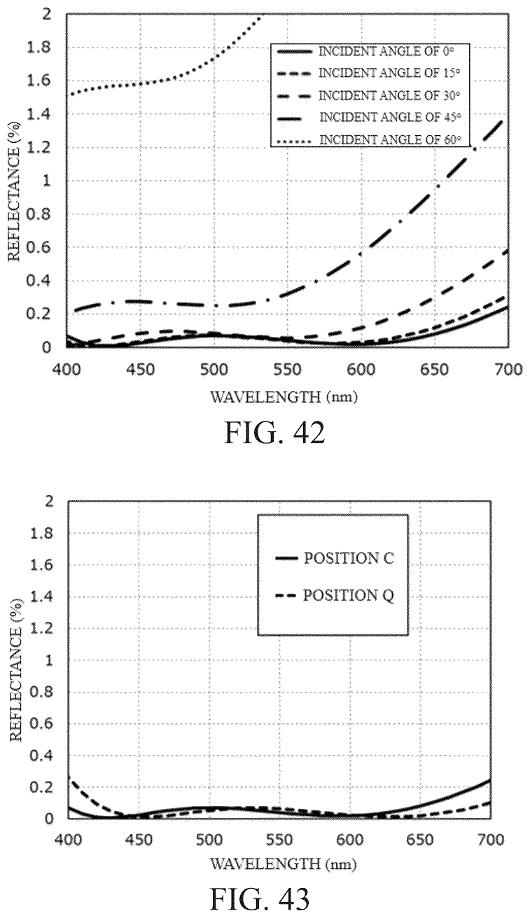

FIG. 42 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 43 illustrates the reflectance characteristic at the incident angle of 0° at positions C and Q. According to Table 17, the film thickness of each thin film layer at position Q is larger than that at position C by approximately 6%, but it can be confirmed that the reflectance characteristic is equal to or smaller than 0.2% for light in a wavelength band of 420 nm to 680 nm and is excellent.

TABLE 17

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 107.5 | 114.5 |
| FLECTION | LAYER 14 | SILICA | | | |
| FILM 101 | THIN FILM | POLYIMIDE | 1.62 | 28.0 | 29.6 |
| | LAYER 13 | RESIN | | | |
| | THIN FILM | SOLID | 1.35 | 26.4 | 27.9 |
| | LAYER 12 | SILICA | | | |
| | THIN FILM | POLYIMIDE | 1.62 | 115.7 | 122.2 |
| | LAYER 11 | RESIN | | | |
| TRANS- | | S-TIL26 | 1.57 | — | — |
| PARENT | | | | | |
| SUBSTRATE | | | | | |
| 201 | | | | | |

### Example 18

FIG. 39 is a schematic sectional view of an optical element 302 according to Example 18. The optical element 302 according to this example is an optical element in which an antireflection film 102 is formed on a transparent substrate 202. The transparent substrate 202 is S-LAH66 (manufactured by OHARA INC.) having a refractive index of 1.77 (for light with a wavelength of 550 nm). The lens surface of the transparent substrate 202 on which the antireflection film 102 is formed has a convex surface shape. The half open angle ϕ at position Q on the maximum ray effective diameter is 60°. As for layer materials, the thin film layer 21 is made of a material including polyimide resin as a primary component, the thin film layer 22 is made of a material including solid silica as a primary component, the thin film layer 23 is made of a material including polyimide resin as a primary component, and the thin film layer 24 is made of a material including hollow silica as a primary component. Table 18 lists details of the film configuration of the optical element according to this example. The refractive indices and film thicknesses of the materials satisfy inequalities (15) to (23), (25) to (27), and (30). Each of the thin film layers 21, 22, 23, and 24 includes an organic compound.

The antireflection film 102 according to this example is formed by the following method.

The antireflection film 102 is formed with the solid silica application solution, the polyimide application solution 1, and the hollow silica application solution.

The polyimide application solution 1 of 0.2 ml is dropped on the lens surface of the transparent substrate 202 and spin-coated at 3000 rpm for 20 seconds. Next, the solid silica application solution of 0.2 ml is continuously dropped on the lens surface of the transparent substrate 201 and spin-coated at 4000 rpm for 20 seconds. In addition, the polyimide application solution 1 of 0.2 ml is continuously dropped on the lens surface of the transparent substrate 202 and spin-coated at 4000 rpm for 20 seconds. Finally, the hollow silica application solution of 0.2 ml is dropped on the lens surface of the transparent substrate 202 and spin-coated at 4000 rpm for 20 seconds. Thereafter, drying is performed in a clean room at room temperature of 23° C. for 24 hours or longer.

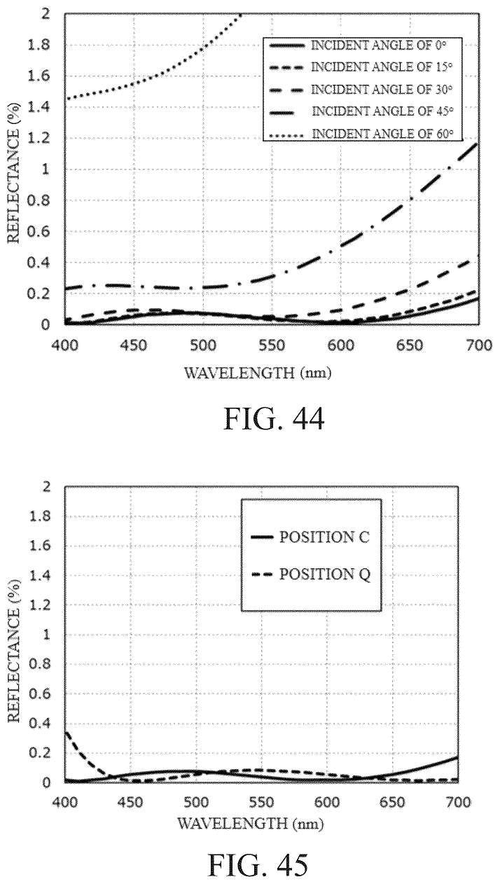

FIG. 44 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 45 illustrates the reflectance characteristic at the incident angle of 0° at positions C and Q. According to Table 18, the film thickness of each thin film layer at position Q is larger than that at position C by approximately 12%, but it can be confirmed that the reflectance is equal to or smaller than 0.2% for light in a wavelength band of 420 nm to 680 nm and is excellent.

TABLE 18

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 102.5 | 114.8 |
| FLECTION | LAYER 23 | SILICA | | | |
| FILM 102 | THIN FILM | POLYIMIDE | 1.62 | 25.0 | 28.0 |
| | LAYER 23 | RESIN | | | |
| | THIN FILM | SOLID | 1.35 | 16.3 | 18.3 |
| | LAYER 22 | SILICA | | | |
| | THIN FILM | POLYIMIDE | 1.62 | 43.8 | 49.0 |
| | LAYER 21 | RESIN | | | |
| TRANS- | | S-LAH66 | 1.77 | — | — |
| PARENT | | | | | |
| SUBSTRATE | | | | | |
| 202 | | | | | |

### Example 19

FIG. 38 is a schematic sectional view of an optical element 301 according to Example 19. The optical element 301 according to this example is an optical element in which an antireflection film 101 is formed on a transparent substrate 201. The transparent substrate 201 is S-TIH53 (manufactured by OHARA INC.) having a refractive index of 1.85 (for light with a wavelength of 550 nm). The lens surface of the transparent substrate 201 on which the antireflection film 101 is formed has a concave surface shape. The half open angle ϕ at position Q on the maximum ray effective diameter is 30°. As for layer materials, the thin film layer 11 is made of a material including polyimide resin as a primary component, the thin film layer 12 is made of a material including solid silica as a primary component, the thin film layer 13 is made of a material including polyimide resin as a primary component, and the thin film layer 14 is made of a material including hollow silica as a primary component. Table 19 lists details of the film configuration of the optical element according to this example. The refractive indices and film thicknesses of the materials satisfy inequalities (15) to (23), (25) to (27), and (30). Each of the thin film layers 11, 12, 13, and 14 includes an organic compound.

The antireflection film 101 according to this example is formed by the following method.

The antireflection film 101 is formed with the solid silica application solution 1, the polyimide application solution 2, and the hollow silica application solution.

The polyimide application solution 2 of 0.2 ml is dropped on the lens surface of the transparent substrate 201 and spin-coated at 3000 rpm for 20 seconds. Next, the solid silica application solution 1 of 0.2 ml is dropped on the lens surface of the transparent substrate 201 and spin-coated at 4000 rpm for 20 seconds. In addition, the polyimide application solution 2 of 0.2 ml is continuously dropped on the lens surface of the transparent substrate 201 and spin-coated at 4000 rpm for 20 seconds. In addition, the hollow silica application solution 1 of 0.2 ml is dropped on the lens surface of the transparent substrate 201 and spin-coated at 4000 rpm for 20 seconds. Thereafter, drying is performed in a clean room at room temperature of 23° C. for 24 hours or longer.

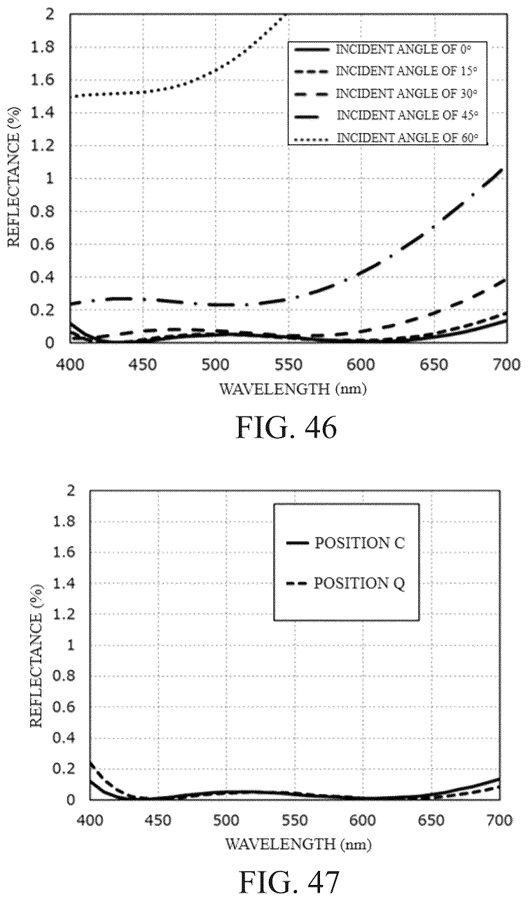

FIG. 46 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 47 illustrates the reflectance characteristic at the incident angle of 0° at positions C and Q. According to Table 19, the film thickness of each thin film layer at position Q is larger than that at position C by approximately 2%, but it can be confirmed that the reflectance characteristic is equal to or smaller than 0.2% for light in a wavelength band of 420 nm to 680 nm and is excellent.

TABLE 19

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 107.4 | 111.1 |
| FLECTION | LAYER 14 | SILICA | | | |
| FILM 101 | THIN FILM | POLYIMIDE | 1.68 | 23.6 | 24.0 |
| | LAYER 13 | RESIN | | | |
| | THIN FILM | SOLID | 1.35 | 17.5 | 17.9 |
| | LAYER 12 | SILICA | | | |
| | THIN FILM | POLYIMIDE | 1.68 | 48.9 | 49.9 |
| | LAYER 11 | RESIN | | | |
| TRANS- | | S-TIH53 | 1.85 | — | — |
| PARENT | | | | | |
| SUBSTRATE | | | | | |
| 201 | | | | | |

### Example 20

FIG. 39 is a schematic sectional view of an optical element 302 according to Example 20. The optical element 302 according to this example is an optical element in which an antireflection film 102 is formed on a transparent substrate 202. The transparent substrate 202 is LPQ-1500 (Manufactured by Mitsubishi Gas Chemical Company, Inc.) having a refractive index of 1.59 (for light with a wavelength of 550 nm). The lens surface of the transparent substrate 202 on which the antireflection film 102 is formed has a convex surface shape. The half open angle ϕ at position Q on the maximum ray effective diameter is 30°. As for layer materials, the thin film layer 21 is made of a material including polyimide resin as a primary component, the thin film layer 22 is made of a material including solid silica as a primary component, the thin film layer 23 is made of a material including polyimide resin as a primary component, and the thin film layer 24 is made of a material including hollow silica as a primary component. Table 20 lists details of the film configuration of the optical element according to this example. The refractive indices and film thicknesses of the materials satisfy inequalities (15) to (23), (25) to (27), and (30). Each of the thin film layers 11, 12, 13, and 14 includes an organic compound. The antireflection film 101 according to this example is formed by the following method.

The antireflection film 102 is formed with the solid silica application solution 1, the polyimide application solution 2, and the hollow silica application solution 1.

The polyimide application solution 2 of 0.2 ml is dropped on the lens surface of the transparent substrate 202 and spin-coated at 3500 rpm for 20 seconds. Next, the solid silica application solution 1 of 0.2 ml is dropped on the lens surface of the transparent substrate 202 and spin-coated at 4000 rpm for 20 seconds. Next, the polyimide application solution 2 of 0.2 ml is dropped on the lens surface of the transparent substrate 202 and spin-coated at 4000 rpm for 20 seconds. In addition, the hollow silica application solution 1 of 0.2 ml is dropped on the lens surface of the transparent substrate 202 and spin-coated at 4000 rpm for 20 seconds. Thereafter, drying is performed in a clean room at room temperature of 23° C. for 24 hours or longer.

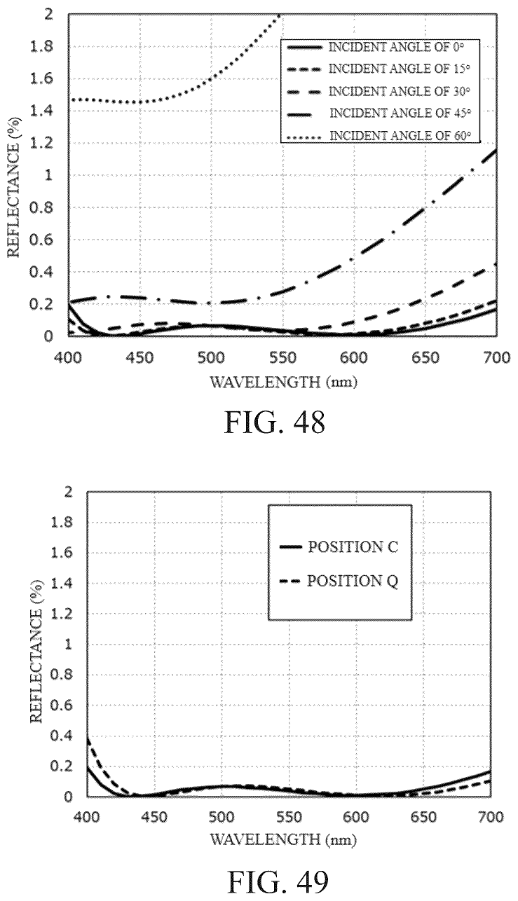

FIG. 48 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 49 illustrates the reflectance characteristic at the incident angle of 0° at positions C and Q. According to Table 20, the film thickness of each thin film layer at position Q is larger than that at position C by approximately 3%, but it can be confirmed that the reflectance is equal to or smaller than 0.2% for light in a wavelength band of 420 nm to 680 nm and is excellent.

TABLE 20

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 119.6 | 115.6 |
| FLECTION | LAYER 24 | SILICA | | | |
| FILM 102 | THIN FILM | POLYIMIDE | 1.68 | 29.7 | 29.1 |
| | LAYER 23 | RESIN | | | |
| | THIN FILM | SOLID | 1.35 | 38.8 | 38.0 |
| | LAYER 22 | SILICA | | | |
| | THIN FILM | POLYIMIDE | 1.68 | 39.2 | 38.4 |
| | LAYER 21 | RESIN | | | |
| TRANS- | | LPQ-1500 | 1.59 | — | — |
| PARENT | | | | | |
| SUBSTRATE | | | | | |
| 202 | | | | | |

### Example 21

FIG. 38 is a schematic sectional view of an optical element 301 according to Example 21. The optical element 301 according to this example is an optical element in which an antireflection film 101 is formed on a transparent substrate 201. The transparent substrate 201 is EP-9000 (manufactured by Mitsubishi Gas Chemical Company, Inc.) having a refractive index of 1.68 (for light with a wavelength of 550 nm). The lens surface of the transparent substrate 201 on which the antireflection film 101 is formed has a concave surface shape. The half open angle ϕ at position Q on the maximum ray effective diameter is 45°. The thin film layer 11 is made of a material including polyimide resin as a primary component, the thin film layer 12 is made of a material including solid silica as a primary component, the thin film layer 13 is made of a material including polyimide resin as a primary component, and the thin film layer 14 is made of a material including hollow silica as a primary component. Table 21 lists details of the film configuration of the optical element according to this example. The refractive indices and film thicknesses of the materials satisfy inequalities (15) to (23), (25) to (27), (30), and (31). Each of the thin film layers 11, 12, 13, and 14 includes an organic compound.

The antireflection film 101 according to this example is formed by the following method.

The antireflection film 101 is formed with the solid silica application solution 1, the polyimide application solution 1, and the hollow silica application solution 1.

The polyimide application solution 1 of 0.2 ml is dropped on the lens surface of the transparent substrate 201 and spin-coated at 4000 rpm for 20 seconds. Next, the solid silica application solution 1 of 0.2 ml is dropped on the lens surface of the transparent substrate 201 and spin-coated at 4000 rpm for 20 seconds. In addition, the polyimide application solution 1 of 0.2 ml is dropped on the lens surface of the transparent substrate 201 and spin-coated at 4000 rpm for 20 seconds. Finally, the hollow silica application solution 1 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

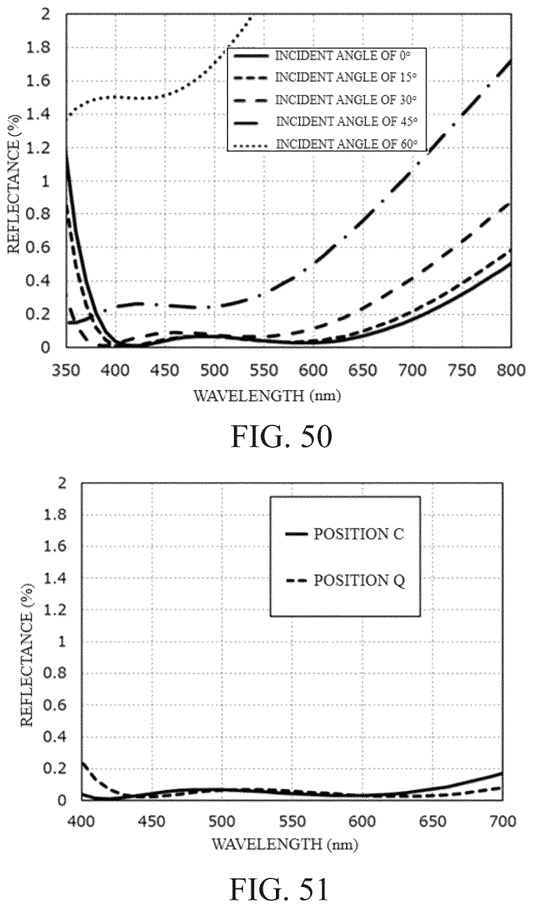

FIG. 50 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 51 illustrates the reflectance characteristic at the incident angle of 0° at positions C and Q. According to Table 21, the film thickness of each thin film layer at position Q is larger than that at position C by approximately 6%, but it can be confirmed that the reflectance characteristic is equal to or smaller than 0.2% for light in a wavelength band of 420 nm to 680 nm and is excellent.

TABLE 21

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 112.2 | 119.5 |
| FLECTION | LAYER 14 | SILICA | | | |
| FILM 101 | THIN FILM | POLYIMIDE | 1.62 | 29.5 | 31.2 |
| | LAYER 13 | RESIN | | | |
| | THIN FILM | SOLID | 1.35 | 28.7 | 30.3 |
| | LAYER 12 | SILICA | | | |
| | THIN FILM | POLYIMIDE | 1.62 | 29.5 | 31.2 |
| | LAYER 11 | RESIN | | | |
| TRANS- | | EP-9000 | 1.68 | — | — |
| PARENT | | | | | |
| SUBSTRATE | | | | | |
| 201 | | | | | |

### Example 22

FIG. 38 is a schematic sectional view of an optical element 301 according to Example 22. The optical element 301 according to this example is an optical element in which an antireflection film 101 is formed on a transparent substrate 201. The transparent substrate 201 is S-BSL7 (manufactured by OHARA INC.) having a refractive index of 1.52 (for light with a wavelength of 550 nm). The lens surface of the transparent substrate 201 on which the antireflection film 101 is formed has a concave surface shape. The half open angle ϕ at position Q on the maximum ray effective diameter is 30°. As for layer materials, the thin film layer 11 is made of a material including polyimide resin as a primary component, the thin film layer 12 is made of a material including solid silica as a primary component, the thin film layer 13 is made of a material including polyimide resin as a primary component, and the thin film layer 14 is made of a material including hollow silica as a primary component. Table 22 lists details of the film configuration of the optical element according to this example. The refractive indices and film thicknesses of the materials satisfy inequalities (15) to (23), (25) to (27), (30), and (31). Each of the thin film layers 11, 12, 13, and 14 includes an organic compound.

The antireflection film 101 according to this example is formed by the following method.

The antireflection film 101 is formed with the solid silica application solution 1, the polyimide application solution 2, and the hollow silica application solution 1.

The polyimide application solution 2 of 0.2 ml is dropped on the lens surface of the transparent substrate 201 and spin-coated at 4000 rpm for 20 seconds. Next, the solid silica application solution 1 of 0.2 ml is dropped on the lens surface of the transparent substrate 201 and spin-coated at 4000 rpm for 20 seconds. In addition, the polyimide application solution 2 of 0.2 ml is dropped on the lens surface of the transparent substrate 201 and spin-coated at 4000 rpm for 20 seconds. Finally, the hollow silica application solution 1 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

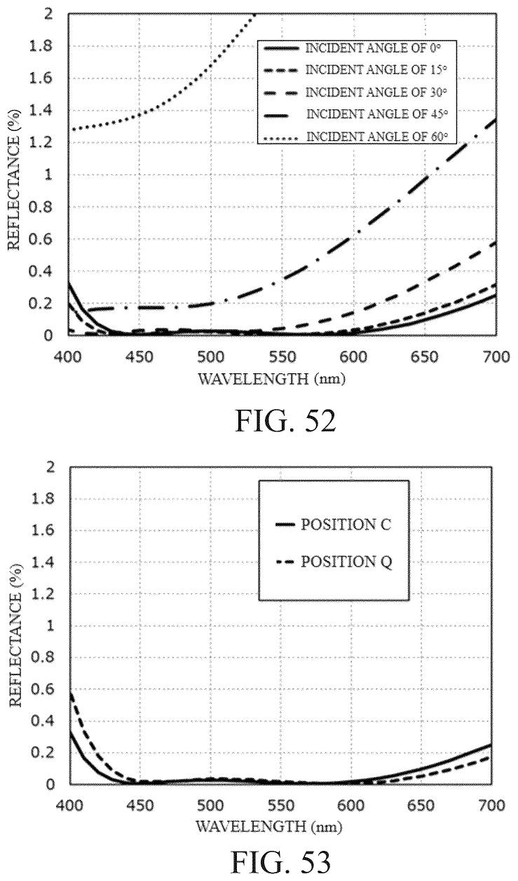

FIG. 52 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 53 illustrates the reflectance characteristic at the incident angle of 0° at positions C and Q. According to Table 22, the film thickness of each thin film layer at position Q is larger than that at position C by approximately 3%, but it can be confirmed that the reflectance characteristic is equal to or smaller than 0.2% for light in a wavelength band of 420 nm to 680 nm and is excellent.

TABLE 22

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 122.5 | 126.7 |
| FLECTION | LAYER 14 | SILICA | | | |
| FILM 101 | THIN FILM | POLYIMIDE | 1.68 | 30.4 | 31.0 |
| | LAYER 13 | RESIN | | | |
| | THIN FILM | SOLID | 1.35 | 45.6 | 46.5 |
| | LAYER 12 | SILICA | | | |
| | THIN FILM | POLYIMIDE | 1.68 | 30.4 | 31.0 |
| | LAYER 11 | RESIN | | | |
| TRANS- | | S-BSL7 | 1.52 | — | — |
| PARENT | | | | | |
| SUBSTRATE | | | | | |
| 201 | | | | | |

### Example 23

FIG. 39 is a schematic sectional view of an optical element 302 according to Example 23. The optical element 302 according to this example is an optical element in which an antireflection film 102 is formed on a transparent substrate 202. The transparent substrate 202 is S-BAM12 (manufactured by OHARA INC.) having a refractive index of 1.64 (for light with a wavelength of 550 nm). The lens surface of the transparent substrate 202 on which the antireflection film 102 is formed has a convex surface shape. The half open angle ϕ at position Q on the maximum ray effective diameter is 45°. As for layer materials, the thin film layer 21 is made of a material including polyimide resin as a primary component, the thin film layer 22 is made of a material including solid silica as a primary component, the thin film layer 23 is made of a material including polyimide resin as a primary component, and the thin film layer 24 is made of a material including hollow silica as a primary component. Table 23 lists details of the film configuration of the optical element according to this example. The refractive indices and film thicknesses of the materials satisfy inequalities (15) to (23), (25) to (27), (30), and (31). Each of the thin film layers 21, 22, 23, and 24 includes an organic compound.

The antireflection film 102 according to this example is formed by the following method.

The antireflection film 102 is formed with the solid silica application solution 1, the polyimide application solution 1, and the hollow silica application solution 1.

The polyimide application solution 1 of 0.2 ml is dropped on the lens surface of the transparent substrate 201 and spin-coated at 4000 rpm for 20 seconds. Next, the solid silica application solution 1 of 0.2 ml is dropped on the lens surface of the transparent substrate 201 and spin-coated at 4000 rpm for 20 seconds. In addition, the polyimide application solution 1 of 0.2 ml is dropped on the lens surface of the transparent substrate 201 and spin-coated at 4000 rpm for 20 seconds. Finally, the hollow silica application solution 1 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

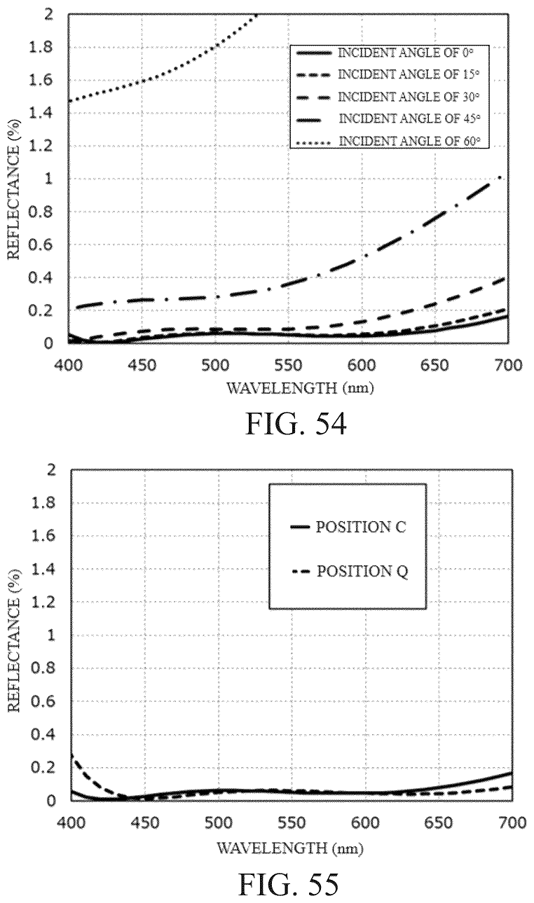

FIG. 54 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 55 illustrates the reflectance characteristic at the incident angle of 0° at positions C and Q. According to Table 23, the film thickness of each thin film layer at position Q is larger than that at position C by approximately 6%, but it can be confirmed that the reflectance is equal to or smaller than 0.2% for light in a wavelength band of 420 nm to 680 nm and is excellent.

TABLE 23

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 111.4 | 118.7 |
| FLECTION | LAYER 24 | SILICA | | | |
| FILM 102 | THIN FILM | POLYIMIDE | 1.62 | 30.3 | 32.0 |
| | LAYER 23 | RESIN | | | |
| | THIN FILM | SOLID | 1.35 | 28.9 | 30.6 |
| | LAYER 22 | SILICA | | | |
| | THIN FILM | POLYIMIDE | 1.62 | 30.3 | 32.0 |
| | LAYER 21 | RESIN | | | |
| TRANS- | | S-BAM12 | 1.64 | — | — |
| PARENT | | | | | |
| SUBSTRATE | | | | | |
| 202 | | | | | |

### Example 24

FIG. 40 is a schematic sectional view of an optical element 303 according to Example 24. The optical element 303 according to this example is an optical element in which an antireflection film 103 is formed on a transparent substrate 203. The transparent substrate 203 is L-BAL43 (manufactured by OHARA INC.) having a refractive index of 1.59 (for light with a wavelength of 550 nm). The glass transition temperature Tg (° C.) of L-BAL43 is 493° C. The lens surface of the transparent substrate 203 on which the antireflection film 103 is formed has a concave surface shape. The half open angle ϕ at position Q on the maximum ray effective diameter is 30°. As for layer materials, the thin film layer 31 is made of a material including aluminum oxide as a primary component, the thin film layer 32 is made of a material including solid silica as a primary component, the thin film layer 33 is made of a material including polyimide resin as a primary component, and the thin film layer 34 is made of a material including hollow silica as a primary component. Table 24 lists details of the film configuration of the optical element according to this example. The refractive indices and film thicknesses of the materials satisfy inequalities (15) to (23), (25) to (27), and (32) to (34). Each of the thin film layers 32, 33, and 34 includes an organic compound.

The antireflection film 103 according to this example is formed by the following method.

The thin film layer 31 is formed by an evaporation method. An electron beam is used to heat an evaporation material. In addition, an ion beam assist evaporation method is performed to form a denser film. The vacuum chamber of an evaporation apparatus is evacuated to a high vacuum region near 2×10-3 (Pa) in a non-heating state. After the high vacuum state inside the vacuum chamber is confirmed, Ar as inert gas is introduced into an ion gun, and then the ion gun is electrically discharged. After the ion gun becomes stable, oxygen is introduced into the vacuum chamber and ion assist evaporation with oxygen ions is performed at the vacuum pressure of approximately 1×10-2 (Pa). With the evaporation method, the film thickness of a lens having a large half open angle decreases as a position moves to a peripheral part.

After the thin film layer 31 is formed by evaporation, the solid silica application solution 1 of 0.2 ml is dropped on the lens surface of the transparent substrate 203 on which the thin film layer 31 is formed, and is spin-coated at 4000 rpm for 20 seconds. Next, the polyimide application solution 1 of 0.2 ml is dropped on the lens surface of the transparent substrate 202 and spin-coated at 4000 rpm for 20 seconds. Finally, the hollow silica application solution 1 of 0.2 ml is continuously dropped on the lens surface of the transparent substrate 203 and spin-coated at 4000 rpm for 20 seconds. Thereafter, drying is performed in a clean room at room temperature of 23° C. for 24 hours or longer.

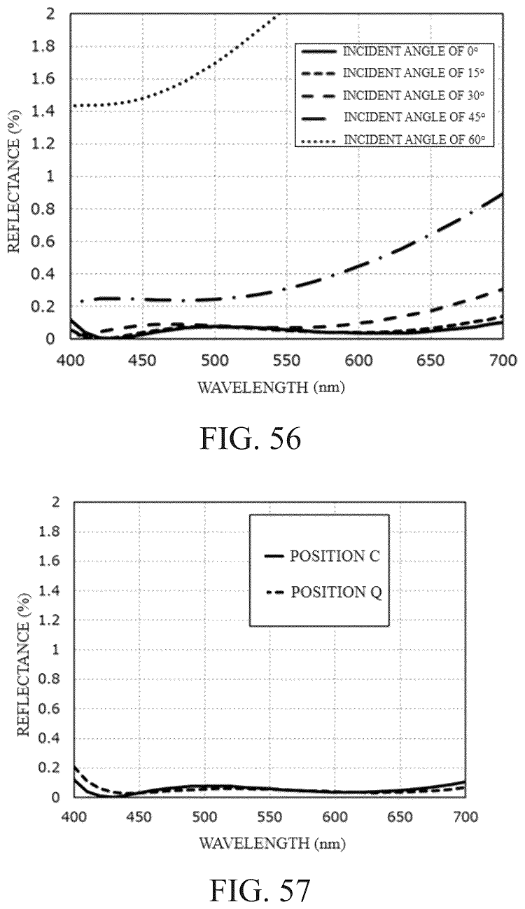

FIG. 56 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 57 illustrates the reflectance characteristic at the incident angle of 0° at positions C and Q. According to Table 24, the film thickness of the thin film layer 31 at position Q is smaller than that at position C by approximately 13% and the film thicknesses of the thin film layers 32, 33, and 34 at position Q are larger than those at position C by approximately 3%, but it can be confirmed that the reflectance characteristic is equal to or smaller than 0.2% for light in a wavelength band of 420 nm to 680 nm and is excellent.

TABLE 24

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 115.5 | 119.5 |
| FLECTION | LAYER 34 | SILICA | | | |
| FILM 103 | THIN FILM | POLYIMIDE | 1.62 | 31.2 | 31.8 |
| | LAYER 33 | RESIN | | | |
| | THIN FILM | SOLID | 1.35 | 33.0 | 33.7 |
| | LAYER 32 | SILICA | | | |
| | THIN FILM | ALUMINUM | 1.64 | 139.4 | 120.7 |
| | LAYER 31 | OXIDE | | | |
| TRANS- | | L-BAL43 | 1.59 | — | — |
| PARENT | | | | | |
| SUBSTRATE | | | | | |
| 203 | | | | | |

### Example 25

FIG. 41 is a schematic sectional view of an optical element 304 according to Example 25. The optical element 304 according to this example is an optical element in which an antireflection film 104 is formed on a transparent substrate 204. The transparent substrate 204 is L-TIL28 (manufactured by OHARA INC.) having a refractive index of 1.69 (for light with a wavelength of 550 nm). The lens surface of the transparent substrate 204 on which the antireflection film 104 is formed has a convex surface shape. The half open angle ϕ at position Q on the maximum ray effective diameter is 40°. As for layer materials, the thin film layer 41 is made of a material including aluminum oxide as a primary component, the thin film layer 42 is made of a material including solid silica as a primary component, the thin film layer 43 is made of a material including polyimide resin as a primary component, and the thin film layer 44 is made of a material including hollow silica as a primary component. Table 25 lists details of the film configuration of the optical element according to this example. The refractive indices and film thicknesses of the materials satisfy inequalities (15) to (23), (25) to (27), and (32) to (34). Each of the thin film layers 42, 43, and 44 includes an organic compound.

The antireflection film 104 according to this example is formed by the following method.

The thin film layer 41 is formed by an evaporation method. The evaporation method is similar to that for the thin film layer 31 according to Example 8.

After the thin film layer 41 is formed by evaporation, the solid silica application solution 1 of 0.2 ml is dropped on the lens surface of the transparent substrate 204 on which the thin film layer 41 is formed, and is spin-coated at 4000 rpm for 20 seconds. Next, the polyimide application solution 2 of 0.2 ml is continuously dropped on the lens surface of the transparent substrate 204 and spin-coated at 4000 rpm for 20 seconds. Finally, the hollow silica application solution 1 of 0.2 ml is continuously dropped on the lens surface of the transparent substrate 204 and spin-coated at 4000 rpm for 20 seconds. Thereafter, drying is performed in a clean room at room temperature of 23° C. for 24 hours or longer.

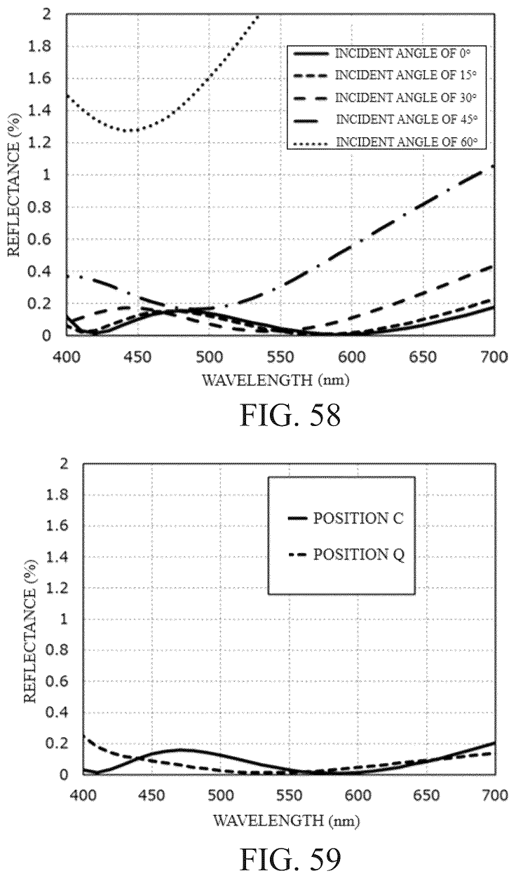

FIG. 58 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. FIG. 59 illustrates the reflectance characteristic at the incident angle of 0° at positions C and Q. According to Table 25, the film thickness of the thin film layer 41 at position Q is smaller than that at position C by approximately 23% and the film thicknesses of the thin film layers 32, 33, and 34 at position Q are larger than those at position C by 5%, but it can be confirmed that the reflectance characteristic is equal to or smaller than 0.2% for light in a wavelength band of 420 nm to 680 nm and is excellent.

TABLE 25

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | CHAIN | 1.19 | 118.5 | 124.5 |
| FLECTION | LAYER 44 | SILICA | | | |
| FILM 104 | THIN FILM | POLYIMIDE | 1.68 | 25.6 | 26.6 |
| | LAYER 43 | RESIN | | | |
| | THIN FILM | SOLID | 1.35 | 38.1 | 39.7 |
| | LAYER 42 | SILICA | | | |
| | THIN FILM | ALUMINUM | 1.64 | 135.6 | 104.4 |
| | LAYER 41 | OXIDE | | | |
| TRANS- | | L-TIM28 | 1.69 | — | — |
| PARENT | | | | | |
| SUBSTRATE | | | | | |
| 204 | | | | | |

The optical element of each of Examples 17 to 25 is also applicable to the optical system 401 of Example 15 described above with reference to FIG. 32. The optical system 400 includes the optical element 301, 302, 303, or 304 on which the antireflection film according to any one of Examples 17 to 25 is formed. In addition, the optical element according to any one of Examples 17 to 25 is also applicable to the image pickup apparatus (digital camera 500) according to Example 16 described above with reference to FIG. 33.

### Comparative Example 3

FIG. 38 illustrates a schematic sectional view of an optical element 301 according to comparative example 3. The optical element 301 according to this comparative example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including aluminum oxide as a primary component, the thin film layer 12 is made of a material including magnesium fluoride as a primary component, the thin film layer 13 is made of a material including aluminum oxide as a primary component, and the thin film layer 14 is made of a material including hollow silica as a primary component. Table 26 lists details of the film configuration of the optical element according to this comparative example. The refractive indices and film thicknesses of the materials satisfy inequalities (15) to (23) but do not satisfy inequalities (25) to (27).

The antireflection film 101 according to this comparative example is formed by the following method. The thin film layers 11, 12, and 13 are formed by an evaporation method. The evaporation method is similar to that of Example 8. After the thin film layers 11, 12, and 13 are formed by evaporation in this order, the hollow silica application solution 1 of 0.2 ml is dropped on the lens surface of the transparent substrate 201 on which the thin film layers 11, 12, and 13 are formed, and is spin-coated at 4000 rpm for 20 seconds. Thereafter, drying is performed in a clean room at room temperature of 23° C. for 24 hours or longer.

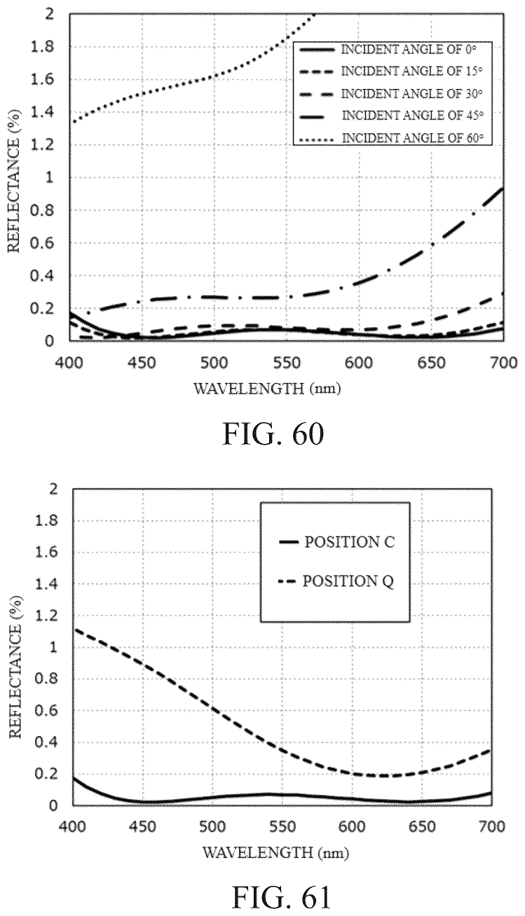

FIG. 60 illustrates the reflectance characteristic at the incident angles of 0°, 15°, 30°, 45°, and 60° at position C. The reflectance is equal to or smaller than 0.2% for light in a wavelength band of 420 nm to 680 nm at an incident angle of 0°, and it can be understood that the reflectance characteristic is extremely favorable. However, the reflectance characteristic at the incident angle of 0° is compared between positions C and Q in FIG. 61, the reflectance characteristic at position Q is lower than that at position C. According to Table 26, the film thickness of the thin film layer 14 at position Q is larger than that at position C by 6%, but the film thicknesses of the thin film layers 11, 12, and 13 at position Q are smaller than those at position C by 30%. Thus, the reflectance characteristic at position Q deteriorates.

TABLE 26

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | HOLLOW | 1.19 | 114.6 | 122.1 |
| FLECTION | LAYER 14 | SILICA | | | |
| FILM 101 | THIN FILM | ALUMINUM | 1.64 | 27.2 | 19.2 |
| | LAYER 13 | OXIDE | | | |
| | THIN FILM | MAGNESIUM | 1.39 | 33.4 | 23.6 |
| | LAYER 12 | FLUORIDE | | | |
| | THIN FILM | ALUMINUM | 1.64 | 126.2 | 89.2 |
| | LAYER 11 | OXIDE | | | |
| TRANS- | | S-TIL26 | 1.57 | — | — |
| PARENT | | | | | |
| SUBSTRATE | | | | | |
| 201 | | | | | |

### Comparative Example 4

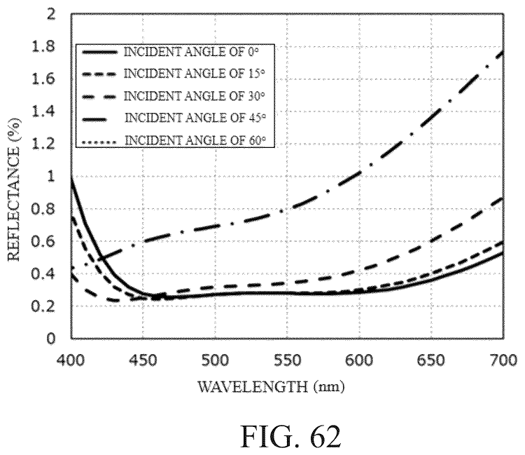

FIG. 62 illustrates a schematic sectional view of an optical element 301 according to comparative example 4. The optical element 301 according to this comparative example is an optical element in which an antireflection film 101 is formed on a transparent substrate 201. The transparent substrate 201 is S-TIL26 (manufactured by OHARA INC.) having a refractive index of 1.57 (for light with a wavelength of 550 nm). The lens surface of the transparent substrate 201 on which the antireflection film 101 is formed has a concave surface shape. The half open angle ϕ at position Q on the maximum ray effective diameter is 45°. As for layer materials, the thin film layer 11 is made of a material including polyimide resin as a primary component, the thin film layer 12 is made of a material including solid silica as a primary component, the thin film layer 13 is made of a material including polyimide resin as a primary component, and the thin film layer 14 is made of a material including chain silica as a primary component. Table 27 lists details of the film configuration of the optical element according to this comparative example. The refractive index of the thin film layer 13 does not satisfy inequality (18).

The antireflection film 101 according to this example is formed by the following method.

The antireflection film 101 is formed with the solid silica application solution 1, the polyimide application solution 1, and the chain silica application solution 2.

The polyimide application solution 1 of 0.2 ml is dropped on the lens surface of the transparent substrate 201 and spin-coated at 3000 rpm for 20 seconds. Next, the solid silica application solution 1 of 0.2 ml is dropped on the lens surface of the transparent substrate 201 and spin-coated at 4000 rpm for 20 seconds. In addition, the polyimide application solution 1 of 0.2 ml is dropped on the lens surface of the transparent substrate 201 and spin-coated at 4000 rpm for 20 seconds. In addition, the chain silica application solution 2 of 0.2 ml is continuously dropped on the lens surface of the transparent substrate 201 and spin-coated at 4000 rpm for 20 seconds. Thereafter, drying is performed in a clean room at room temperature of 23° C. for 24 hours or longer.

FIG. 62 illustrates the reflectance characteristic at the incident angles of 0°, 15°, 30°, 45°, and 60° at position C. The reflectance is equal to or larger than 0.2% for light in a wavelength band of 420 nm to 680 nm at an incident angle of 0°, and thus sufficient antireflection characteristics are not obtained.

TABLE 27

| | | | | PHYSICAL | |
|---|---|---|---|---|---|
| | | | | FILM | |
| | | | | THICKNESS | |
| | | | | (mm) | |
| | | | | POSI- | POSI- |
| | | | REFLEC- | TION | TION |
| | | | TANCE | C | Q |
| ANTIRE- | THIN FILM | CHAIN | 1.30 | 107.0 | — |
| FLECTION | LAYER 14 | SILICA | | | |
| FILM 101 | THIN FILM | POLYIMIDE | 1.62 | 57.2 | — |
| | LAYER 13 | RESIN | | | |
| | THIN FILM | SOLID | 1.35 | 10.0 | — |
| | LAYER 12 | SILICA | | | |
| | THIN FILM | POLYIMIDE | 1.62 | 79.9 | — |
| | LAYER 11 | RESIN | | | |
| TRANS- | | S-TIL26 | 1.57 | — | — |
| PARENT | | | | | |
| SUBSTRATE | | | | | |
| 201 | | | | | |

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical element that can sufficiently reduce reflectance irrespective of the refractive index of a substrate.

This application claims the benefit of Japanese Patent Application No. 2023-085504, which was filed on May 24, 2023, and Japanese Patent Application No. 2024-039020, which was filed on Mar. 13, 2024, and which are hereby incorporated by reference herein in its entirety.

What is claimed is:

1. An optical element comprising:
a base material; and
an antireflection film,
wherein the antireflection film consists of a first layer formed on the base material, a second layer formed on the first layer, and a third layer formed on the second layer,
wherein each of the first layer, the second layer, and the third layer includes an organic compound, and
wherein the following inequality is satisfied:
$$1.10 \leq n 3 \leq 1.28$$
where n3 is a refractive index of the third layer for light with a wavelength of 550 nm.

2. An optical element comprising:
a base material; and
an antireflection film,
wherein the antireflection film consists of a first layer formed on the base material, a second layer formed on the first layer, and a third layer formed on the second layer, and
wherein the following inequalities are satisfied:
$$1.3 \leq n 1 \leq 1.5$$
$$1.56 \leq n 2 \leq 1.7$$
$$1.1 \leq n 3 \leq 1.28$$
$$10 \leq n 1 d 1 \leq 155$$
$$10 \leq n 2 d 2 \leq 155$$
$$100 \leq n 3 d 3 \leq 155$$
$$200 \leq n 1 d 1 + n 2 d 2 + n 3 d 3 \leq 300$$
where n1 is a refractive index of the first layer for light with a wavelength of 550 nm, n2 is a refractive index of the second layer for the light with the wavelength of 550 nm, n3 is a refractive index of the third layer for the light with the wavelength of 550 nm, d1 (nm) is a thickness of the first layer, d2 (nm) is a thickness of the second layer, and d3 (nm) is a thickness of the third layer.

3. The optical element according to claim 2, wherein each of the first layer, the second layer, and the third layer includes an organic compound.

4. The optical element according to claim 1, wherein the following inequalities are satisfied:
$$1. < d 1 q / d 1 c \leq 1.3$$
$$1. 0 < d 2 q / d 2 c \leq 1.3$$
$$1. 0 < d 3 q / d 3 c \leq 1.3$$
where d1c (nm), d2c (nm), and d3c (nm) are a thickness of the first layer, a thickness of the second layer, and a thickness of the third layer, respectively, at an intersection of a reference axis that passes a surface vertex of an optical surface of the base material, on which the antireflection film is formed, and the optical surface, and d1q (nm), d2q (nm), and d3q (nm) are a thickness of the first layer and a thickness of the second layer, and a thickness of the third layer, respectively, at a position farthest from the intersection in an effective area of the optical surface.

5. The optical element according to claim 1, wherein a thickness of each of the first layer and the second layer is smallest at a center of the antireflection film and becomes larger at a position farther from the center.

6. The optical element according to claim 1, wherein the first layer includes acrylic resin.

7. The optical element according to claim 1, wherein the first layer includes solid particles.

8. The optical element according to claim 1, wherein the second layer includes epoxy resin or polyimide resin.

9. The optical element according to claim 1, wherein the following inequality is satisfied:
$$1. 45 \leq n s \leq 2.1$$
where ns is a refractive index of the base material for the light with the wavelength of 550 nm.

10. The optical element according to claim 2, wherein the following inequality is satisfied:
$$0.9 \leq d 1 / d 3 \leq 1.1 .$$

11. The optical element according to claim 1, wherein the following inequality is satisfied:
$$1.55 \leq n s \leq 1.7$$
where ns is a refractive index of the base material for the light with the wavelength of 550 nm.

12. The optical element according to claim 1, wherein the following inequality is satisfied:
$$450 \leq T g \leq 550$$
where Tg (° C.) is a glass transition temperature of the base material.

13. The optical element according to claim 4, wherein in a wavelength band of 450 nm or more and 650 nm or less, reflectance of the antireflection film for light incident on the intersection at an incident angle of 0° is 0.5% or less, and the reflectance of the antireflection film for light incident on the intersection at an incident angle of 30° is 1.0% or less.

14. The optical element according to claim 1, wherein the following inequality is satisfied:
$$1.12 \leq n 3 \leq 1.25 .$$

15. The optical element according to claim 1, wherein a layer of the antireflection film that is farthest from the base material includes a void.

16. The optical element according to claim 1, wherein a layer of the antireflection film that is farthest from the base material includes at least one of solid particles, chain particles, and hollow particles.

17. The optical element according to claim 16, wherein at least one of the solid particles, the chain particles, and the hollow particles are made of silica.

18. The optical element according to claim 1, further comprising a film including fluororesin formed on the antireflection film.

19. An optical system comprising a plurality of optical elements including the optical element according to claim 1.

20. The optical system according to claim 19, wherein the following inequality is satisfied:
$$25 \leq ϕ < 90$$
where ϕ (degrees) is a half open angle at a position of an effective diameter of an optical surface on which the antireflection film is formed on the base material.

21. An image pickup apparatus comprising:
the optical system according to claim 19; and
an image sensor configured to capture an object through the optical system.

22. A manufacturing method of an optical element that includes a base material, and an antireflection film that includes a first layer, a second layer, and a third layer, the manufacturing method comprising the steps of:
forming the first layer formed on the base material using a wet coating method;
forming the second layer formed on the first layer using the wet coating method; and
forming the third layer formed on the second layer using the wet coating method,
wherein the following inequality is satisfied:
$$1.10 \leq n 3 \leq 1.28$$
where n3 is a refractive index of the third layer for light with a wavelength of 550 nm.

23. The manufacturing method according to claim 22, wherein the wet coating method is a spin coating method.
